(19) United States
(12) Patent Application Publication
(10) Pub. No.: US 2021/0290478 A1
(43) Pub. Date: Sep. 23, 2021

(54) THIGH THERAPEUTIC COMPRESSION APPARATUS, SYSTEM, AND METHODS OF USE

(71) Applicant: Sun Scientific, Inc., Dobbs Ferry, NY (US)

(72) Inventors: Sundaram Ravikumar, Briadcliff Manor, NY (US); Vikram Ravikumar, New York, NY (US); Guy Osborne, Trumbull, CT (US); Harry Allan Alward, Shelton, CT (US); David Maseau, Dobbs Ferry, NY (US)

(73) Assignee: Sun Scientific, Inc., Dobbs Ferry, NY (US)

(21) Appl. No.: 16/846,211

(22) Filed: Apr. 10, 2020

Related U.S. Application Data
(60) Provisional application No. 62/832,258, filed on Apr. 10, 2019.

(51) Int. Cl. A61H 9/00

(52) U.S. Cl. CPC A61H 9/0092; A61H 2201/0103; A61H 2201/165; A61H 2205/108; A61H 2201/5071; A61H 2205/102; A61H 2201/5056

(57) ABSTRACT

A thigh therapeutic compression apparatus for providing pressure to a limb or other body part namely a thigh, including a bladder assembly having at least one bladder within a primary wrap and/or a secondary wrap. The primary wrap includes an inflation port to connect to an inflation means which provides either constant or varying pressure within the bladder and a check valve is included in the inflation port and/or inflation means. The primary wrap is connected to a stabilization means configured to be attached to a belt or other means around the waist of the body.

### RELATED APPLICATIONS

The present application claim priority from provisional application Ser. No. 62/378,581 filed Apr. 10, 2019 and entitled “Thigh Therapeutic Compression Apparatus, System and Methods of Use”, the entire contents of which are hereby incorporated herein by reference for all purposes.

### BACKGROUND OF THE INVENTION

### I. Field of the Invention

The subject invention is directed generally to a device for applying compression to a limb, and more particularly, to a therapeutic apparatus for applying compression to the leg of an individual in conjunction with the treatment of conditions such as deep vein thrombosis (DVT), chronic venous insufficiency (CVI) and lymphedema, and more specifically to a thigh therapeutic compression apparatus. The apparatus includes a wrap having a bladder and an inflation means for the bladder with the apparatus capable of applying compression to a limb such as the full leg, thigh, calf, knee, and/or foot of a patient.

### II. Background of the Related Art

Normally, a healthy leg muscle, for example, squeezes the deep veins of the legs and feet to help move blood back to the heart. One-way valves in the deep leg veins keep blood flowing back towards the heart. However, prolonged periods of standing or sitting can cause the walls of the deep leg veins to stretch. Over time, in susceptible individuals, this can weaken the vein walls and damage the valves, causing blood to pool in the veins and increase venous blood pressure. This may result in a condition known as chronic venous insufficiency (CVI).

Treatment of CVI typically involves the use of compression stockings or medical hosiery to decrease chronic swelling. Compression stockings are elastic stockings that squeeze the veins to improve venous circulation and prevent excess blood from flowing backward. Compression stockings can also help to heal skin sores or stasis ulcers that often present in conjunction with CVI. It is also common to employ compression bandages to apply pressure to the leg. In this regard, a bandage is applied with constant tension so as to produce graduated compression with the highest pressure at the ankle. However, the technique is difficult and is often done by highly skilled caregivers.

Highly effective mechanical compression devices have also been developed for treating CVI, which are disclosed, for example, in U.S. Pat. Nos. 7,276,037 and 7,559,908, the disclosures of which are incorporated by reference herein in their entireties. These devices include a flexible wrap that carries a manually inflatable air bladder and is adapted to be securely positioned around the leg of an individual to apply localized pressure to a treatment site. The device also includes a fluid-filled wound dressing that can be applied directly to the skin for applying localized pressure and even a medicament to a venous ulcer when it is enveloped by the flexible wrap. While this device is effective for applying localized compression to the leg, it is not configured to apply localized compression to the thigh of a user or the foot to prevent swelling and further improve venous circulation to the thigh, calf, or whole leg.

Lymphedema, also known as lymphatic obstruction, is another condition of localized fluid retention and tissue swelling, and is caused by a compromised lymphatic system. Treatment for lymphedema varies depending on the severity of the edema and the degree of fibrosis of the affected limb. The most common treatments for lymphedema are manual compression lymphatic massage, compression garments or bandaging. Elastic compression garments are typically worn by persons with lymphedema on the affected limb following complete decongestive therapy to maintain edema reduction.

Compression bandaging, also called wrapping, involves the application of several layers of padding and short-stretch bandages to the involved areas. Short-stretch bandages are preferred over long-stretch bandages (such as those normally used to treat sprains), as the long-stretch bandages cannot produce the proper therapeutic tension necessary to safely reduce lymphedema and may in fact end up producing a tourniquet effect. During activity, whether exercise or daily activities, the short-stretch bandages enhance the pumping action of the lymph vessels by providing increased resistance for them to push against. This encourages lymphatic flow and helps to soften fluid-swollen areas.

Known methods for CVI and lymphedema treatment, like compression bandaging, have several disadvantages. The bandaging is time consuming and the effectiveness is limited to the skill of the provider. In some instances, bandages can be applied too tightly or too loosely and may slip from their intended position, decreasing their effectiveness. When this occurs, bandages must be taken off and reapplied, further increasing the time of application and decreasing the consistency of application of the therapy. Further, when the compression bandaging is on the thigh area of the leg, the bandaging slips down the leg when the user walks or moves around even in bed, possibly due to the anatomical shape of the thigh tapering towards the knee area.

The effectiveness of many of the current compression therapies is limited by the application of current products. Because current compression therapy is done either with manual wraps or electromechanical systems, they require either a skilled medical processional to apply and/or the need for the patient to be stationary for extended periods of time. Although stockings and/or bandages can be worn by patients and self-administered, they are very difficult for the patient to put on and pose a challenge for unskilled medical professionals to apply consistently and effectively. Again though, the stockings and/or bandages will slip down the thigh towards the knee once the user walks or moves around.

CVI and lymphedema may also result in DVT, which is an affliction that causes blood clots particularly in the lower extremities of the legs. When a patient is not ambulatory, the patient faces an elevated risk factor of creating a blood clot. These blood clots, which often accumulate or reside in the patient's calf or thigh, are not, in and of themselves, overly dangerous. However when the blood clot breaks loose, they create a pulmonary embolism which can get lodged in the patient's heart, brain or lungs where it can cause significant damage or death. It is estimated that in each year 2 to 2.5 million Americans are afflicted by DVT causing 600,000 patients to seek medical care with 300,000 patients succumbing to the effects of the pulmonary embolism. Thus, a system and apparatus and method of use to treat DVT is needed.

Many of the current treatment options for CVI and lymphedema cause venous ulcers including the use of current known devices, apparatus, bandages, stocking, hosiery and the like. A venous ulcer is damage and loss of skin above the ankle that is the result of a problem with the veins in the leg. Venous ulcers typically develop on either side of the lower leg, above the ankle and below the calf. They are difficult to heal and often recur. They also develop on the thigh, on the inner portion of the leg thigh or outer thigh area as well as near the groin area on the leg. Further, venous ulcers may develop around the knee, behind the knee, along the sides and on the front of the knee as well.

The veins of the leg are divided into the superficial and deep systems according to their position relative to the fascia. The deep veins, which come together to form the popliteal and femoral veins lie within the fascia and are responsible for the venous return from the leg muscles. Dilated valveless sinusoids also lie within the fascia (more particularly in the soleus and gastrocnemius muscles). The sinusoids fill with blood when the leg is at rest.

The long saphenous vein which runs along the medial side of the leg from foot to groin and the short saphenous vein which runs at the back of the calf from foot to knee are the major vessels of the superficial venous system. These vessels lie outside the fascia and are responsible for the venous return from the skin and subcutaneous fat. Compression on the long saphenous vein may be recommended in treatment of certain conditions whereas in other conditions there may be less compression recommendation on the long saphenous vein on the medial side of the leg and more compression recommended on the short saphenous vein of the leg which runs on the back portion of the leg, including the thigh.

Communicating veins, sometimes called perforators because they perforate the deep fascia, join the two systems. The perforators, like the other veins in the leg, contain valves that permit the flow of blood in one direction only, from the outer or superficial system inwards to the deep veins.

The venous pressure at the ankle of a subject who is lying supine is around 10 mmHg, but on standing this will rise considerably due to an increase in hydrostatic pressure (equivalent to the weight of a vertical column of blood stretching from the point of measurement to the right auricle of the heart).

During walking, as the foot is dorsally flexed, the contraction of the calf muscle compresses the deep veins and soleal sinuses thereby emptying them of blood. As the foot is plantarly flexed, the pressure in the veins falls, the proximal valves close, and the veins are refilled by blood passing through the perforators from the superficial system. During this cycle, in a normal leg, the distal valves of the deep veins and the valves of the perforators will ensure that the expelled blood can go in only one direction—upwards, back to the heart.

Blockage or damage to the venous system will cause disruption to normal blood flow, which may manifest itself in a number of different ways according to the site and extent of the damage. If the valves in the superficial system are affected, venous return will be impaired and blood may accumulate in the veins causing them to become distended, leading to the formation of varicosities (varicose veins). Such varicosities may be located in the thigh, knee, calf, ankle or foot area of the user's leg.

If the function of the perforator valves is impaired, the action of the calf muscle pump will tend to cause blood to flow in the reverse direction into the superficial system increasing the possibility of damage to the superficial vessels. There may be minimal blood flow upward into the thigh and the rest of the body, causing issues for the patient along the body including the thigh, calf, ankle and entire leg of the patient.

Following a deep vein thrombosis that results in complete or partial obstruction of a deep vein, the unrelieved pressure produced by the calf muscle pump on the perforator valves may cause these to become incompetent. If this occurs, there will be a large rise in the pressure in the superficial system, which may force proteins and red cells out of the capillaries and into the surrounding tissue. Here, the red cells break down releasing a red pigment that causes staining of the skin, an early indicator of possible ulcer formation. The ulcer formation can be in any part of the body, including the leg, groin, thigh, knee, calf, ankle and foot.

Venous leg ulcers are generally shallow and red in color. The skin surrounding the ulcer is frequently discolored due to the staining described previously. Incompetent perforating vein valves can also cause malleolar venules to become dilated and appear as fine red threads around the ankle as well as the thigh, knee, calf or foot are of the leg or any area of the leg. This condition, called ankle flair, is also diagnostic of a venous ulcer. The condition may also be seen on the thigh, including the inner medial thigh area or outer lateral thigh area, or around the knee or groin area of the patient's body.

Arteries transport oxygen replenished blood from the heart to the rest of the body. Veins return oxygen depleted blood back to the heart. When the veins in the lower extremities of the body have difficulty transporting blood back to the heart, a condition develops called chronic venous insufficiency (CVI), also known as chronic venous disease (CVD). CVI most commonly occurs as the result of a blood clot in the deep veins of the legs, a disease known as deep vein thrombosis (DVT). CVI also results from pelvic tumors and vascular malformations, and sometimes occurs for unknown reasons. When a person is standing or sitting, blood in the veins of the legs flows in an upward direction. When the person walks, the calf muscles and muscles in the feet contract to squeeze the veins and push the blood upward. To keep the blood flowing upward and prevent it from flowing downward, the veins contain one-way valves. CVI occurs when these valves become damaged and allow the blood to leak back downward in the opposite direction. Such valve damage may occur as the result of aging, extended sitting or standing, or a combination of aging and reduced mobility. When the veins and valves become weakened and the blood does not properly flow up to the heart, blood pressure in the veins of the lower extremities can stay elevated for long periods of time, leading to CVI. This condition is more common in older individuals, and if not properly treated, can lead to burst capillaries, local tissue inflammation, internal tissue damage, varicose veins, ulcers, and open sores on the skin's surface. The burst capillaries can be seen on the patient's leg including the thigh, knee and groin.

CVI can diminish the capacity of the venous system and increase the workload of the lymphatic system in the affected area. The lymphatic system must then transport larger volumes of water and protein to reduce the fluid load in the affected tissues of the legs, a situation which is especially difficult for patients with lymphedema, varicose veins, and other lower extremity pathology.

One non-surgical option often used to help prevent or treat the leg extremity pathologies discussed above is the use of compression stockings. Compression stockings help prevent leg fatigue, ankle and foot swelling, spider veins, and varicose veins. They improve circulation in the legs, especially when used in conjunction with frequent exercise and leg elevation. Compression stockings maintain pressure on the legs while allowing for normal ambulation. Increasing pressure in the tissues beneath the skin reduces excess leakage of fluid from the capillaries and increases absorption of tissue fluid by the capillaries and lymphatic vessels. In addition, the increased pressure decreases the size of the veins, which causes the blood to flow faster and help prevent it from pooling.

Compression stocking tightness typically varies between 15-50 mm HG. The tightness of a given stocking depends on its particular configuration and class. For example, stockings having a compression pressure of 15-20 mm HG are considered light compression stockings. Class I stockings are 20-30 mm Hg, class II stockings are 30-40 mm Hg, and class III stockings are 40-50 mm Hg.

While such compression stockings are a commonly utilized non-invasive treatment of leg pathology, the issues they present are numerous. Wearing a tightly fitting stocking can be tedious or time consuming to put on, and may require help from another person if the wearer is injured, elderly, or has some form of disability. Any tight fitting stocking to be worn on the thigh area has a harder time being put on as the user has to pull the tight fitting stocking over the foot, ankle, calf, knee and finally up to the thigh area. Again, due to the shape of the thigh, these tight fitting stocking will slip down the thigh at some point due to the user walking or moving about.

In addition, the pressure applied by the stocking generally stays relatively constant during use without any option of increasing or decreasing the tightness level. As compression stockings are repeatedly worn, they lose elasticity and thus tightness over time. Once such prescribed elasticity and tightness is lost, the stocking is of little or no value, and needs to be replaced on account of its looseness, which requires buying a new pair to obtain the desired pressure. Further, given the shape of the thigh, the top or upper portion of the stocking must be very tight in order to prevent slippage down the thigh, which can in turn lead to complications of its own due to the excessive tightness.

Medical hosiery represents a useful and convenient method of applying compression to normal shaped legs in order to prevent the development or recurrence of leg ulcers. However, these stockings are of limited value in the treatment of active ulceration, being difficult to apply over dressings. In such situations compression bandages currently represent the treatment of choice. Compression bandages apply a pressure to the limb that is directly proportional to bandage tension but inversely proportional to the radius of curvature of the limb to which it is applied. This means, therefore, that a bandage applied with constant tension to a limb of normal proportions will automatically produce graduated compression with the highest pressure at the knee. This pressure will gradually reduce up the thigh as the circumference increases.

As can be readily appreciated, it is cumbersome and difficult to apply uniform tension to the compression bandage as it is applied to the treated limb, and thus this is accomplished only by highly skilled caregivers. Moreover, once secured to the treated limb, care and attention must be given to ensure that the bandage does not slip or become displaced as this will lead to multiple layers forming, which in turn may lead to localized areas of high pressure, which can place the patient in direct risk of skin necrosis.

Mechanical compression treatments have also been proposed. An exemplary compression device is described in U.S. Pat. No. 5,031,604 to Dye. As generally described at col. 2, lines 33 et seq., an arrangement of chambers are provided that circumscribe the leg. An active pneumatic control system controls the pressure in the chambers to squeeze the leg near the ankle and then squeeze sequentially upward toward the knee in order to move blood from the extremity toward the heart. As noted in col. 4, lines 20-59 of U.S. Pat. No. 6,488,643 to Tumey et al., the mechanically produced compression levels may produce ischaemic (i.e., localized tissue anemia) not noted at similar compression levels obtained through bandaging. It may also produce cuffing (i.e., a reduction in leg pulsatile blood flow). The pneumatic control system is also bulky and heavy, which severely limits the mobility of the patient during treatment. Moreover, the pneumatic control system fails to provide a mechanism to ensure that excessive pressure, which can cause necrosis, is not applied to the treated limb. These limitations have resulted in most mechanical compression devices being contraindicated for patients exhibiting DVT. Consequently, those skilled in the art have to date avoided such mechanical compression devices for the treatment of venous ulcers or edema of the extremities.

Co-owned U.S. Publication No. 2004/0193084, which is hereby incorporated by reference herein in its entirety, discloses a device for applying pressure to the human leg for use in conjunction with treatment of varicose veins. The device includes a flexible member and at least one air bladder chamber integral thereto that are adapted to securely wrap around the human leg. A tube in fluid communication with the air bladder chamber(s) extends to an air pumping mechanism that operates to inflate the air bladder chamber(s) to a pressurized state. The flexible member preferably includes an opening at the knee joint level to enable a patella to protrude therethrough. In addition, the flexible member preferably extends below knee joint level and is adapted to securely wrap around a lower portion of a leg to provide stability to the leg. Preferably, the air bladder chamber of the device is substantially longer in a first dimension than in a second dimension orthogonal thereto such that the air bladder chamber can be positioned to cover a portion of the human leg that is relatively long in the vertical dimension and narrow in the horizontal dimension.

Co-owned U.S. Pat. No. 7,276,037, which is hereby incorporated by reference herein in its entirety, discloses an apparatus for applying compression therapy to an extremity of the human body, such as a portion of the human leg. The device includes a flexible member and an air bladder chamber. The flexible member is adapted to wrap around the extremity to secure the air bladder chamber to the extremity. An air pumping mechanism is operated to inflate the air bladder chamber to a pressurized state. One or more fluid-filled pressurized members are provided, each separate and distinct from the flexible member and the air bladder chamber and thus readily moveable relative to the flexible member and the air bladder chamber. The pressurized member(s) is operably disposed between the extremity and the flexible member whereby it applies increased localized pressure to the extremity during use. Preferably, the air bladder chamber is substantially longer in a first dimension than in a second dimension orthogonal thereto such that it can extend longitudinally along the extremity to cover a relatively long and narrow portion of the extremity. The position of the air chamber can be readily adapted to apply local pressure to desired body parts (such as a certain venous channel). The pressurized member(s) can be positioned during use such that it covers a venous ulcer (or other treatment sites) and applies increased localized pressure to the treatment site in order to promote healing.

Surgical treatments for leg vascular issues include Sclerotherapy which is a medical procedure used to eliminate varicose veins and spider veins. Sclerotherapy typically involves an injection of a solution (generally a salt solution) directly into the vein. The solution irritates the lining of the blood vessel, causing it to collapse and stick together and the blood to clot. Post-operative procedures may require compression bandaging or stockings, both of which have the problems described above in regard to slippage down the thigh to the knee as well as cost and need for a skilled level of knowledges in order to properly bandage the sclerotherapy treatment area.

A need exists for a system in which a compression garment includes a universal connector to a variety of pumps. Thus, the user could interchange between an intermittent pneumatic pressure pump, for instance when seated, and then change to a set pressure pump for instance when walking. The various type of pumps are not limited to the two listed above but could be any type of pump with a universal connector.

Further a need exists for a system in which a multiple of compression garments have separate active pressures. For instance, the inventive thigh compression garment could be used in conjunction with a lower leg compression apparatus such as that described (and incorporated herein as reference) in U.S. Pat. Nos. 9,033,906 and 7,967,766 and 7,559,908 and U.S. Ser. No. 13,444,600 and therefore the user could wear two separate therapeutic compression apparatus on the entire leg and could also include an optional knee wrap. In this instance the user could have one pressure level on the inventive thigh therapeutic compression apparatus whereas a calf compression garment could have a second pressure level and both compression garments are connected to one pneumatic pump configured to have multiple pressure outlets. Such a need exists for such a system.

In regard to thigh compression garments, such known compression garments for the user's thigh have a tendency to slip down the user's leg so that the garment either bunches at the knee or falls down the thigh towards the knee and rests above the knee rather than midway on the thigh. The location of the thigh compression garment should remain in place and any movement due to gravity as the user walks can affect the efficacy of the treatment for CVT, DVT and/or lymphedema, as well as other treatments. The thigh region may be the area of a user's leg between the hip and knee. The basic anatomy of the leg may cause the slippage in that part to the shape of leg anatomy conical in nature and facilitates slippage in a downward direction of the leg.

Users have attempted to reduce slippage of a thigh wrap downward toward the knee by tightening the wrap as much as possible, but this can result in cutting off circulation and other complications. Some users have added adhesive tape to adhere the thigh wrap (whether it is a bandage or compression garment) to the user's skin, but this also can result in complications. Thus, a need exists for a thigh compression garment with reduced slippage down to the knee. A need exists for a thigh compression garment with reduced slippage due to gravity.

All current known treatment apparatus, devices, bandages, stockings and hosiery have the problems of stability (no slippage), maintaining sufficient effective pressure without overpressure complications, maintaining compression and the like. Further all known apparatus, devices, bandages, stockings and hosiery, though especially the current treatment apparatus and devices, are only capable of connecting to one source of compression or inflation means and no universal inflation port of connector is known—wherein a patient could vary treatment through varying the inflation source and inflation means for the treatment apparatus or device.

Other known problems with the current treatment apparatus and devices, bandages, stockings and hosiery is the requirement that a skilled care-giver apply the current treatment apparatus and devices, bandages, stockings and hosiery. Such a skilled care-giver may not be available to all patients, notably those without long-term care insurance or provided a skilled home-health aid. Yet another known problem is leakage of set compression within the treatment apparatus and devices, bandages, stockings and hosiery resulting in an ineffective treatment and ineffective apparatus or device and the like which may be rendered useless to the patient and user. A further problem with the current treatment apparatus and devices, bandages, stockings and hosiery is that the inflation means or source of compression is set up as either manual or mechanical or electrical and cannot be interchanged in that the inflation port or inflation means is not universal and interchangeable. Yet another problem with the current treatment apparatus and devices, bandages, stockings and hosiery is that the inflation means or source is either static or intermittent and again cannot be changed during the treatment with such apparatus or device. Yet another problem with the current treatment apparatus and devices, bandages, stockings and hosiery is that the apparatus and device, bandages, stocking and hosiery slips down the leg due to gravity and/or walking or movement of the user.

The apparatuses, methods, assemblies and systems of the subject invention provide benefits and advantages that may overcome a number of problems with respect to known compression technologies, particularly the problems that arise due to the difficulty of applying current compression wrap technologies. The subject invention provides an alternative to known technologies that employ tight-fitting therapeutic elastic garments, which cause patients discomfort, and lose their elasticity as well as have slippage down the leg, and therefore their effectiveness over time. Those skilled in the art will readily appreciate that it would be beneficial to provide a therapeutic compression device and system for treating CVI, DVT and lymphedema that is adapted and configured to apply localized compression to the leg, thigh, calf and/or foot to prevent swelling and further improve venous circulation, that may also be self-administered by a patient effectively.

Without limitation, the inventive thigh therapeutic compression apparatus may be used with any required compression therapy, such as venous disease, vascular disease, lymphedema and the like. The inventive thigh therapeutic compression apparatus may be used to treat any general swelling as well as being used post operatively for example including in cases of sclerotherapy or vein ablation. The inventive thigh therapeutic compression apparatus may be used by a person for compression therapy such as athletes and lactic acid build up, or pregnant women, as well as any individual who walks a lot or is on their feet at work for period of time.

The inventive thigh therapeutic compression apparatus may be used to compress the long saphenous vein which runs along the medial side of the leg from foot to groin and the short saphenous vein which runs at the back of the calf from foot to knee are the major vessels of the superficial venous system. The inventive thigh therapeutic compression apparatus may also be used to compress the vessels which lie outside the fascia and are responsible for the venous return from the skin and subcutaneous fat. The inventive thigh therapeutic compression apparatus may be used in treatment where there may be different compression profiles on the medial long saphenous vein compared to a different compression profile on the short saphenous vein on the back of the thigh, or any combination. Other uses for the inventive thigh therapeutic compression apparatus may be envisioned.

### SUMMARY OF THE INVENTION

The subject invention is directed to a therapeutic compression apparatus, system and methods of use. The thigh therapeutic compression apparatus has a horizontal proximal edge for positioning towards for instance a hip, pelvis or upper thigh of the leg, a horizontal distal edge for positioning towards for instance a knee, and first and second peripheral edges perpendicular to the horizontal proximal edge and the horizontal distal edge. The thigh therapeutic compression apparatus includes a stabilization means to stabilize the thigh therapeutic compression wrap from slipping down the thigh of the user when in use.

The thigh therapeutic compression apparatus may further comprise at least one bladder operatively associated with the thigh therapeutic compression apparatus for applying pressure to a treatment site on the limb such as a leg. The thigh therapeutic compression apparatus includes a connecting means such as a loop and hook material in order to wrap the thigh therapeutic compression apparatus around the thigh of the user. This connecting means or wrap may include at least one interior pocket for accommodating the at least one bladder. Alternatively, the at least one bladder may be integral with the connecting means or wrap. One or more connecting means may be operatively associated along the first and second peripheral edges of the thigh therapeutic compression apparatus for securing it around the limb.

The at least one bladder may be adapted and configured to form a predetermined gradient compression profile when the at least one bladder is filled. The predetermined gradient profile forms a gradient compression profile when the air bladder is inflated thereby compressing the thigh of the use. The at least one bladder may be one of a wedge-shaped bladder, a cone-shaped bladder, a disk-shaped bladder or a rectangular-shaped bladder. The at least one bladder may also include a plurality of fluid chambers. The thigh therapeutic compression apparatus may further comprise at least one means for adjusting pressure coupled to the at least one bladder for controlling an amount of pressure supplied to the treatment site.

In another embodiment of the present invention, the thigh therapeutic compression apparatus includes two bladders, a lateral bladder and a medial bladder. The medial bladder has a gradient compression profile based on the geometric location of the spot welds located on the medial bladder. The lateral bladder may be connected to the medial bladder and the lateral bladder also has a separate gradient compression profile based on the geometric location of the spot welds on the medial bladder. In another embodiment there is no lateral bladder and only a medial bladder. In yet another embodiment the lateral bladder is not connected to the medial bladder as the medial bladder is closed off and each bladder is inflated via a separate inflation port, and each of the lateral bladder and medial bladder may have a different gradient compression profile based on the predetermined configuration of the sport welds and/or lines within each of the bladders.

The securing means may be configured in one embodiment to be attached to a belt or other means so as to stabilize the thigh therapeutic compression apparatus to the user when in use. In another embodiment the securing means is configured to have a belt inserted within the means of at least one aperture to stabilize the therapeutic compression apparatus on the user when in use. In yet another embodiment the stabilization means may be a garter belt configuration with a connecting means to a series of apertures located on the proximal end of the separate wrap. In any of these embodiments, the securing means may also be configured as an adjustable strap around the waist, or hip, or upper thigh area of a user.

The thigh therapeutic compression apparatus may further comprise an adjustable belt along a proximal horizontal edge of the apparatus for securing it around the limb such as for instance the leg. The thigh therapeutic compression apparatus may be formed at least in part of a non-elastic composite material comprising a plurality of distinct layers. In one embodiment, the composite material may comprise three distinct layers: an inner laminate layer, an outer hook-compatible layer, and a middle non-elastic layer provided between the inner and outer layers. The composite material may also be provided with a plurality of stitched darts and gathers for contouring the apparatus to the limb such as for instance the leg or thigh area of the leg.

The subject invention is also directed to a bladder assembly for a compression apparatus for providing pressure to a limb such as a thigh. The bladder assembly comprises at least one bladder having first and second flexible walls secured to one another about a peripheral edge thereof to form an air pocket; and at least one spot weld provided in a predetermined location inward of the peripheral edge connecting the first and second walls to one another to define a plurality of chambers within the bladder. The geometric placement of the at least one spot weld determines a compression profile of the at least one bladder. The compression profile may be a gradient compression profile.

An inflation means for inflating the bladder (or bladders if two separate unjoined medial bladder and lateral bladder) such as the air pocket through at least one inflation port may be provided in the first wall of the bladder assembly. The inflation means may be detachable from the at least one inflation port. At least one pressure valve may be operatively associated with the inflation means for controlling an amount of pressure within the bladder and the air pocket within the bladder. The inflation port includes a check vale so as to maintain a given pressure within the bladder of the therapeutic compression apparatus. The inflation port may be universal in that it is configured to be capable of connecting to and accepting a plurality of inflation sources and inflation means such as a manual pump, mechanical pump, electrical pump, battery-operated pump, static pump, intermittent pump, pneumatic pump, negative pressure source and other variations.

A method of the invention includes the therapeutic treatment apparatus used to treat CVI, DVT and/or lymphedema by applying the primary and secondary wraps around a limb by a patient and inserting an inflation means into an inflation port and inflating the bladders within the primary and secondary wraps and maintaining a certain pressure or compression profile along the medial saphenous vein and/or the lateral saphenous vein, or to treat the CVI, DVT and/or lymphedema.

Another embodiment of the present invention includes an assembly according to the invention includes a pressure mechanism having a flexible member for attachment to a limb and an air chamber which may be pumped up into a desired pressurized state, a separate relatively small pre-filled air bladder, an absorbent foam, sponge or dressing coupled to the pre-filled air bladder, and a suction conduit coupled to a source of negative pressure (suction) and in fluid communication with the absorbent foam, sponge or dressing. In a preferred embodiment, the pre-filled air bladder, the absorbent foam, sponge or dressing and the suction conduit are formed together as a unit.

According to one aspect of the invention, the flexible member of the pressure mechanism is adapted to wrap around a leg or arm and over the pre-filled air bladder in order to secure the pre-filled air bladder and the foam, sponge or dressing to a wound or ulcer in the extremity. Thus, the flexible member is provided with some fixation structure such as a hook and loop closure mechanism. An air pumping mechanism is preferably coupled to the air chamber of the pressure mechanism in order to inflate the air chamber to a pressurized state. The air chamber of the pressure mechanism is preferably designed to apply pressure or compression along a predefined area (e.g., the saphenous vein of a leg) as opposed to around an entire limb.

According to another aspect of the invention, the suction conduit is located either between the pre-filled air bladder and the absorbent foam, sponge or dressing which is adhered to the small air bladder, or the pre-filled air bladder is formed as a donut with a central opening and the suction conduit extends through the central opening. By coupling the suction conduit to a source of negative pressure, exudate from the wound or ulcer is sucked through the foam, sponge or dressing into the suction conduit.

One of the methods of the invention include locating the pre-filled air bladder and foam, sponge or dressing over a wound or ulcer on a limb, wrapping the flexible member of the pressure mechanism around a limb with the air chamber located over the pre-filled air bladder/absorbent foam, sponge or dressing, and fastening the pneumatic pressure mechanism in place with the fixation structure. When the apparatus is properly located and affixed to the limb, the air chamber is inflated, preferably to 30-40 mm Hg, thereby applying pressure or compression to the limb and more specifically via the pre-filled air bladder to the wound. The suction apparatus is activated by turning on the source of negative pressure, and exudate from the wound or ulcer is pulled through the absorbent foam, sponge or dressing into the suction conduit.

Another embodiment of the present invention includes an apparatus for applying intermittent pressure or compression to a portion of the human body, such as an area of the human leg, which assists with the healing and treatment of various conditions such as venous ulcers or wounds by promoting blood flow into and out of the area and by increasing drainage. The apparatus may include a thigh bladder or a foot bladder and a leg bladder, each having inflatable chambers that accommodate an entering fluid by inflating. The bladders are fluidly coupled by a fluid conduit, and each is preferably equipped with a means for locating it on a portion of the body. In a preferred embodiment, the thigh bladder is position between the pelvis or groin or hip area of the user and the knee of the user. As a person walks while wearing the apparatus, a portion of the thigh bladder deflates as the person's leg moves foot (heel) strikes the ground due to the external pressure placed on the foot bladder, thereby forcing fluid out of the foot bladder, through the fluid conduit, and into the leg bladder, which raises the pressure therein. As the person's foot rolls from heel to toe in the standard walking motion, the external pressure from the person's weight is removed from the foot bladder, resulting in the pressure of the leg bladder being higher than the pressure in the foot bladder. Fluid thus flows back through the fluid conduit and into the foot bladder, which then inflates again to its original state, such that the pressures of the foot bladder and leg bladder are equalized. This process repeats as a person walks, thereby creating a pumping or kneading force on the leg as the pressure in the leg bladder intermittently increases and decreases, thereby promoting blood flow, fluid drainage, treatment, and healing to various parts of the leg.

In another embodiment including a thigh therapeutic compression apparatus and an integral or separate lower leg therapeutic compression apparatus including a foot bladder, the foot bladder is positioned on a bottom of a foot and the leg bladder is positioned on a lower portion of a leg. As a person walks while wearing the apparatus, a portion of the foot bladder deflates as the person's foot (heel) strikes the ground due to the external pressure placed on the foot bladder, thereby forcing fluid out of the foot bladder, through the fluid conduit, and into the leg bladder, which raises the pressure therein. As the person's foot rolls from heel to toe in the standard walking motion, the external pressure from the person's weight is removed from the foot bladder, resulting in the pressure of the leg bladder being higher than the pressure in the foot bladder. Fluid thus flows back through the fluid conduit and into the foot bladder, which then inflates again to its original state, such that the pressures of the foot bladder and leg bladder are equalized. This process repeats as a person walks, thereby creating a pumping or kneading force on the leg as the pressure in the leg bladder intermittently increases and decreases, thereby promoting blood flow, fluid drainage, treatment, and healing to various parts of the leg.

In one embodiment of the present invention, the thigh therapeutic compression apparatus includes a stabilization means such as at least one aperture configured to contain a belt or other means to secure the therapeutic compression apparatus to the user's waist when in use and stabilize the thigh therapeutic compression apparatus to reduce slippage downward towards the knee. In another embodiment of the invention the stabilization means is a series of apertures on the top horizontal edge of the thigh therapeutic compression apparatus configured to the attached to a hook or other connecting means to a garter belt or other means secured around the user's waist. Other stabilization means to reduce slippage of the thigh therapeutic compression apparatus may be included.

These and other aspects of the contacts of the subject invention will become more readily apparent from the following description taken in conjunction with the drawings.

### BRIEF DESCRIPTION OF THE DRAWINGS

So that those having ordinary skill in the art to which the subject invention pertains will more readily understand how to make and use the apparatuses of the subject invention, preferred embodiments thereof will be described in detail herein below with reference to the drawings, wherein:

FIG. 1 is a view of one embodiment of the present invention including a thigh therapeutic compression apparatus for the left leg of a user, constructed in accordance with the present invention, including one air bladder having a medial bladder portion joined to a lateral bladder portion and including a stabilization means having a belt located at the user's waist and connected to the thigh therapeutic compression apparatus via an aperture on the proximal end of the apparatus;

FIG. 2 is an exploded view of the embodiment of the present invention of FIG. 1

FIG. 3 is a view of the present invention of FIG. 1 in use on the left thigh of an individual and a manual pump connected to the universal port illustrating the lateral and medial bladders both in an inflated state;

FIG. 4 is another embodiment of the present invention including a thigh therapeutic compression apparatus for the left leg of a user constructed in accordance with the present invention, including two separate air bladders of a medial bladder portion and a lateral bladder portion and including a stabilization means having a belt located at the user's waist and connected to the thigh therapeutic compression apparatus via an aperture on the proximal end of the apparatus;

FIG. 5 is another embodiment of the present invention including a thigh therapeutic compression apparatus for the left leg of a user, constructed in accordance with the present invention, including one medial air bladder and including a stabilization means having a belt located at the user's waist and connected to the thigh therapeutic compression apparatus via an aperture on the proximal end of the apparatus;

FIG. 6 is another embodiment of the present invention including a thigh therapeutic compression apparatus for either leg of the user (left or right) constructed in accordance with the present invention, showing the layout of through-holes throughout the compression garment as viewed from the interior of the garment and an optional knee pad and stabilization means includes a series of apertures configured to connect to a connecting means;

FIG. 7 is another embodiment of a belt system for use with the embodiment of the present invention of FIG. 6; and

FIGS. 8A-8F is a flow representation of the method of use of the thigh therapeutic compression apparatus of FIG. 1.

### DETAILED DESCRIPTION OF THE PREFERRED EMBODIMENTS

Preferred embodiments of the subject invention are described below with reference to the accompanying drawings, in which like reference numerals represent the same or similar elements. One of ordinary skill in the art would appreciate that while the apparatuses discussed herein relate to compression therapy of the leg and foot, the scope of the invention is not limited to those exemplary applications and may be sized and shaped for the anatomical portion for which compression therapy is needed.

The subject invention provides compression to a patient's limbs, including the extremities, including for example, the leg of a user and more specifically the thigh of a user, in a manner that is simpler and more convenient than current systems. Any limb or body part may be compressed by the instant therapeutic compression apparatus such as for instance a foot, calf, thigh, knee, leg, hip, buttocks, waist, torso, ribs, shoulder, arm, hand, fingers, neck, head or the like.

The subject invention provides system for providing compression and preventing swelling of a limb such as for instance the thigh using a non-elastic binder and bladder which can be used for compression. The bladder is provided within a non-elastic wrap and creates compression in a manner that allows for consistent measuring of the pressure supplied, as well as safe, comfortable, convenient, effective, self-application by the patient.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” would include a plurality of such stimuli and reference to “the signal” would include reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

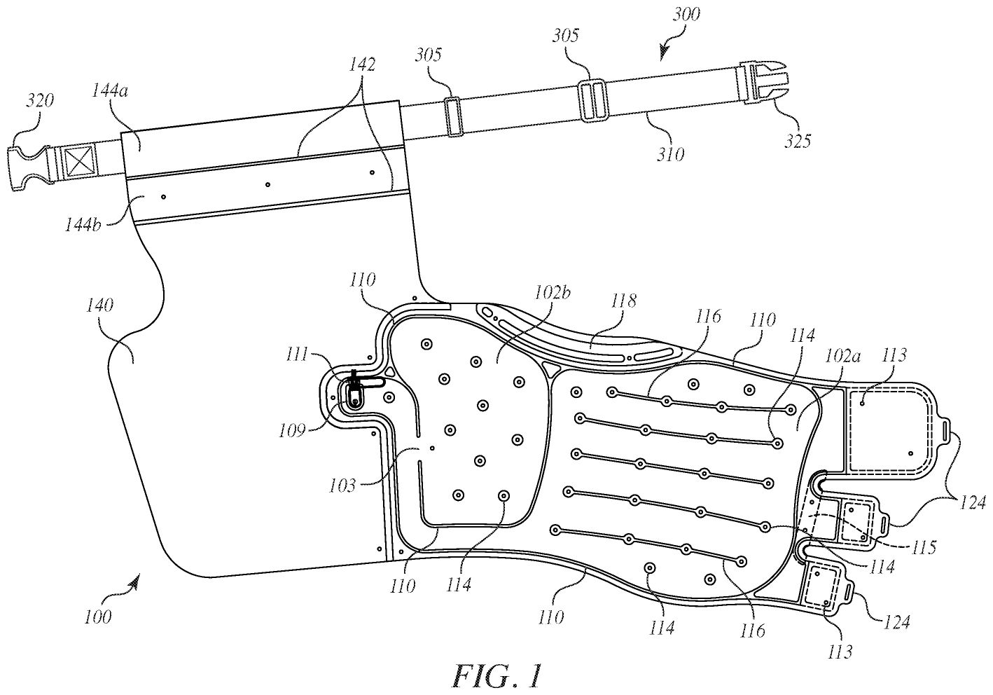

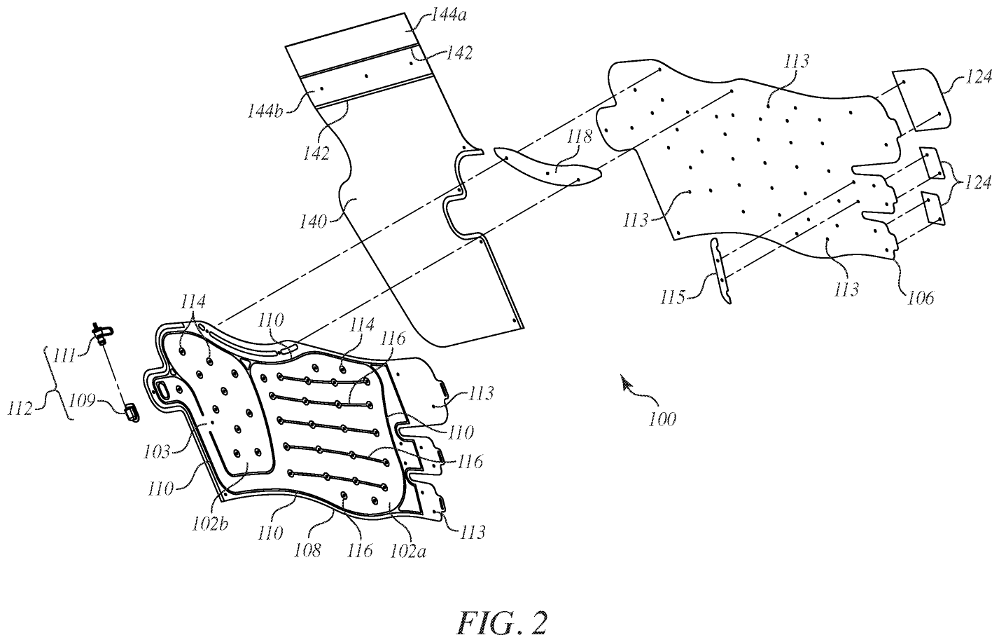

Referring now to FIG. 1, there is illustrated an exemplary embodiment of a thigh therapeutic compression apparatus 100 according to the subject invention showing compression bladder 102 integrally formed in the thigh therapeutic compression apparatus 100. The compression bladder 102 includes a medial bladder portion 102A and a lateral bladder portion 102B. The medial bladder portion 102A when in use is located along the medial saphenous vein of the individual on the inner thigh and the lateral bladder portion 102b when in use is located along the lateral saphenous vein of the individual on the back thigh. The thigh therapeutic compression apparatus 100 as shown in FIGS. 1-5 is configured and adapted to wrap around a patient's limb such as in this instance a left thigh, though it could be used in other limbs. An embodiment not shown of the thigh therapeutic compression apparatus 100 is configured and adapted to wrap around a patient's limb such as in this instance a right thigh and would be the mirror image of the inventive thigh therapeutic compression apparatus as shown in FIGS. 1-5 so that the medial bladder 102A would be located on the inner thigh area of the right leg and the lateral bladder portion 102B (if included) would be located on the back thigh of the user. The thigh therapeutic compression apparatus 100 is formed out of continuous outer sheet 108 and inner sheet 106. The thigh therapeutic compression apparatus 100 is a wrap member with a proximal end portion (top as oriented in FIGS. 1 and 2) and opposed distal end portion (bottom as oriented in FIGS. 1 and 2) which is configured and adapted to conform around a patient's thigh and provide compression through the inflation of bladder 102. Inner sheet 106 and outer sheet 108 are made out of a nylon laminated polyurethane sheet which are configured and adapted to be RF welded together. However, any other suitable materials which are weldable or otherwise joined while being airtight can be used. Continuous peripheral weld line 110 forms an airtight boundary of integrally formed bladder 102. In this exemplary embodiment, bladder 102 is a single continuous bladder throughout however, it is envisioned that the thigh therapeutic compression apparatus 100 could have an independent bladder either separately inflatable or inflatable through a one-way valve or other desired inflation/deflation configuration.

In this embodiment, hook and loop fasteners 124 are provided along the edge of inner and outer sheets in order to ease adjustment and secure therapeutic compression apparatus 100 on a patient's limb such as for example a thigh. It is envisioned that the therapeutic compression apparatus 100 can also be secured to a patient's thigh by other means, such as zippered, buttoned, or be cuff shaped by other such suitable means. Further, it is also envisioned that hook and loop closures 124 can be replaced by material similar to that of stabilization means 140 (such as a hip or waist stabilizer) described below and be welded/sewn/attached to bladder 102 for improved comfort.

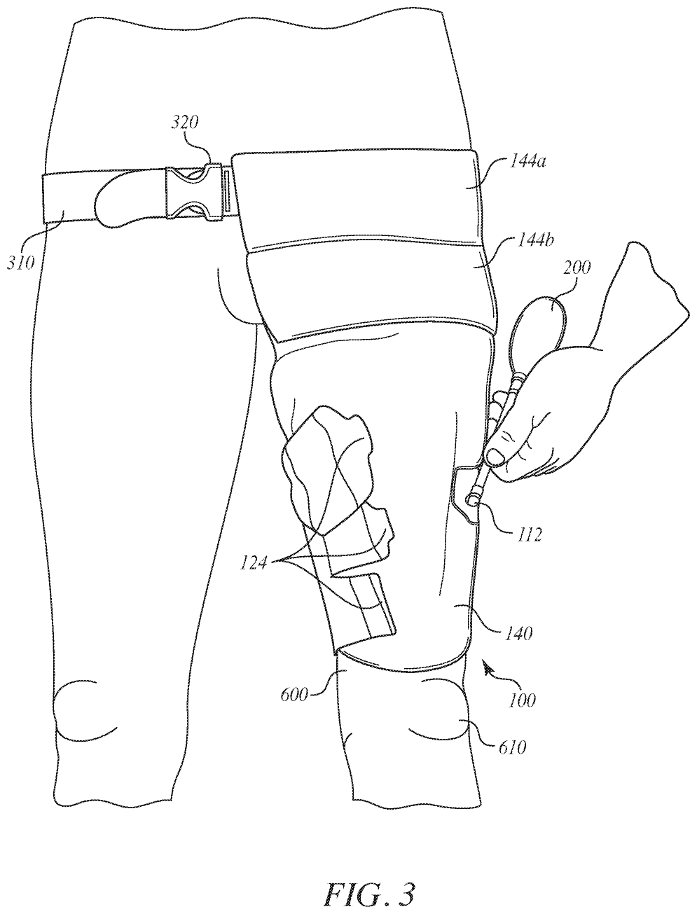

In this embodiment inflation means is a device 130 which is a hand pump 200 (as shown in FIG. 3) capable of attaching to inflation port 112 to inflate bladder 102 (102A, 102B, 402). It can be appreciated that a mechanical or automatic inflation pump (not shown) can also be attached to inflation port 112 to inflate and deflate bladder 102 (102A, 102B, 402) to provide pulsating pressure to a user's thigh. A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. A vent valve (not shown) can also be incorporated into thigh therapeutic compression apparatus 100 or with inflation means 130 to allow a user to selectively deflate bladder 102 (102A, 102B, 402). Further, a check valve or relief valve is incorporated with either inflation means 130 or bladder 102 (102A, 102B, 402)to prevent over-inflation once a maximum pressure is detected. Examples of relief valves are described in U.S. Pat. Nos. 7,276,037 and 7,850,629, the disclosures of which are incorporated by reference in their entirety.

The thigh therapeutic compression apparatus 100 includes a panel 118 located along the proximal end portion of the thigh therapeutic compression apparatus configured to conform to the groin area of the leg. The panel 118 may be comprised of a flexible material such as but not limited to nylon, polyurethane, cotton, or other suitable material, or a material such as Spandex. The panel 118 may be configured to prevent the occurrence of a pinch point and reduce pressure on a patient's groin area when wearing the thigh therapeutic compression apparatus 100.

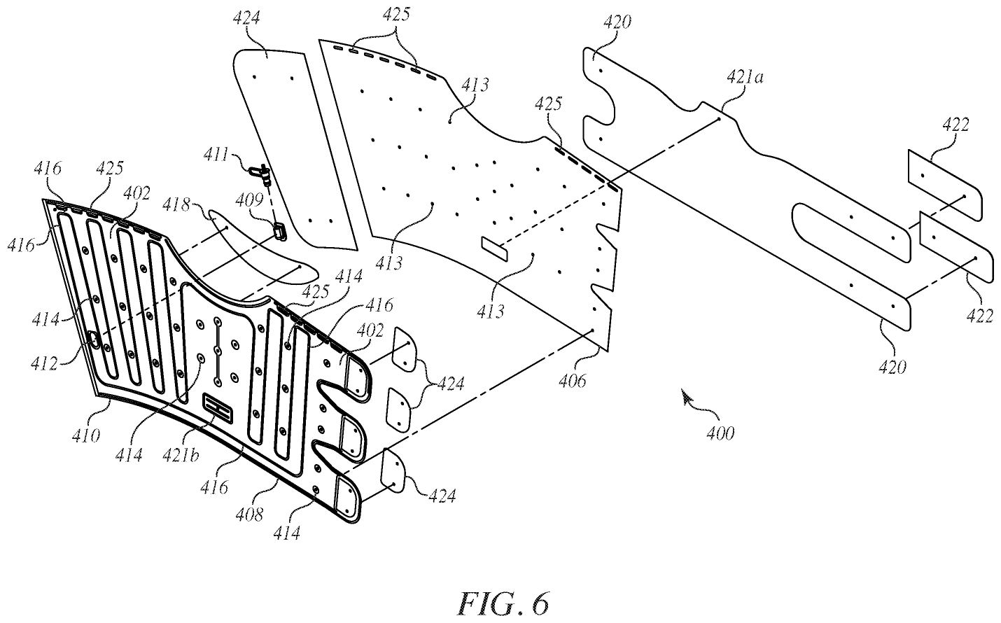

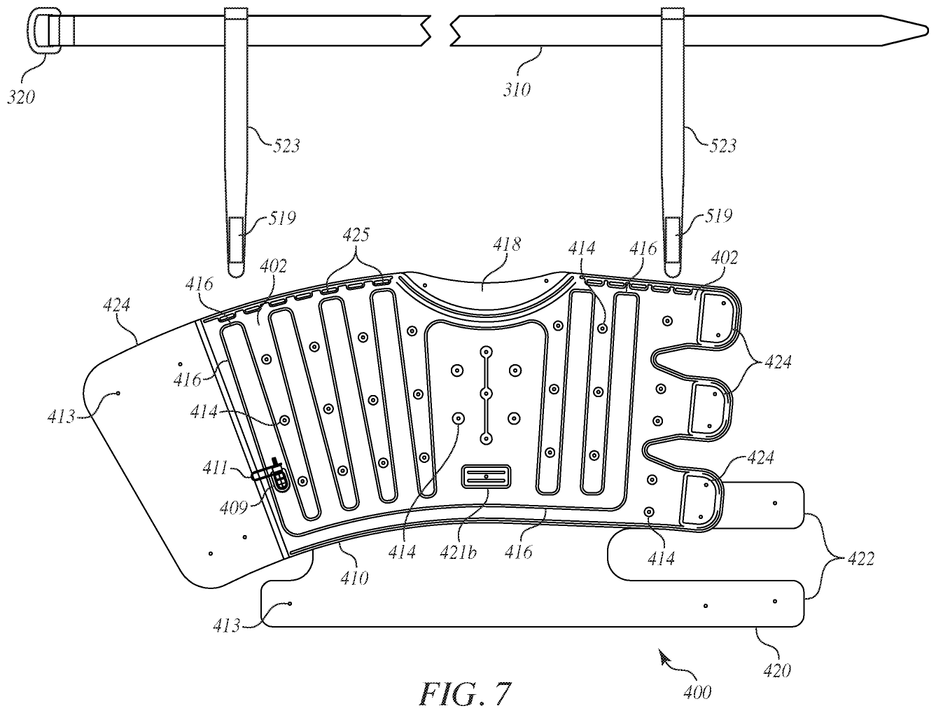

Referring now to FIGS. 1-2, by forming bladder 102 (102A and 102B) to be integral within inner sheet 106 and outer sheet 108, the location and desired preconfigured compression gradient profile can be obtained cost-effectively. A number of different embodiments of bladder configurations can be used in the thigh therapeutic compression apparatus 100 of the subject invention such as those configurations described above. FIGS. 1 and 2 show therapeutic compression apparatus 100 having bladder 102A, 102B with a plurality of spot welds 114 therein. Spot welds 114 are strategically placed within bladder 102 (102A and 102B) in a predetermined pattern based on the desired gradient profile relative to the compression needed at the patient's treatment site. Spot welds 114 enable bladder 102 (102A and 102B) to define the gradient profile when inflated through inflation port 112. The geometric placement of spot welds 114 within bladder 102 allows increased inflation of certain portions of bladder 102 (102A and 102B), and can create one or more fluid chambers within bladder 102. In this embodiment fluid chambers the bladder 102 is comprised of two bladders with air flowing between each bladder, for example the medial bladder 102A located in use along the inner portion of the patient's thigh and the lateral bladder 102B located in use along the patient's back and/or outer thigh. In this exemplary embodiment, bladder 102 is a single continuous bladder comprised of two portions of a bladder such as the medial bladder 102A and lateral bladder 102B. This configuration is particularly useful when compression is needed to improve fluid movement (e.g., blood, lymph, etc.) within the body. Further, linear weld lines 116 allow for better compression along the inner though and outer thigh of a patient's thigh by increasing tension applied to the medial portion of the thigh of a patient and thus further forming the predetermined gradient compression profile. This increased tension can generate a more effective thigh compression in order to increase venous flow. Linear weld lines 116 located horizontally along the medial portion of the thigh create a ribbed portion, which keeps the inflated profile of therapeutic compression apparatus 100 compact which can further increase ambulation and reduce interference with a patient's clothes. While not shown, the linear weld lines 116 could also be located vertically along the medial bladder portion 102A and/or the lateral bladder portion 102B, such as the vertical linear weld lines 416 as seen in FIGS. 6 and 7. Other combinations of linear weld lines 116, 416 and spot welds 114, 414 may be used to create a predetermined gradient compression profile for the bladders 102, 102A, 102B, 402 and thus apply gradient compression onto the leg or other limb, body part when in use.

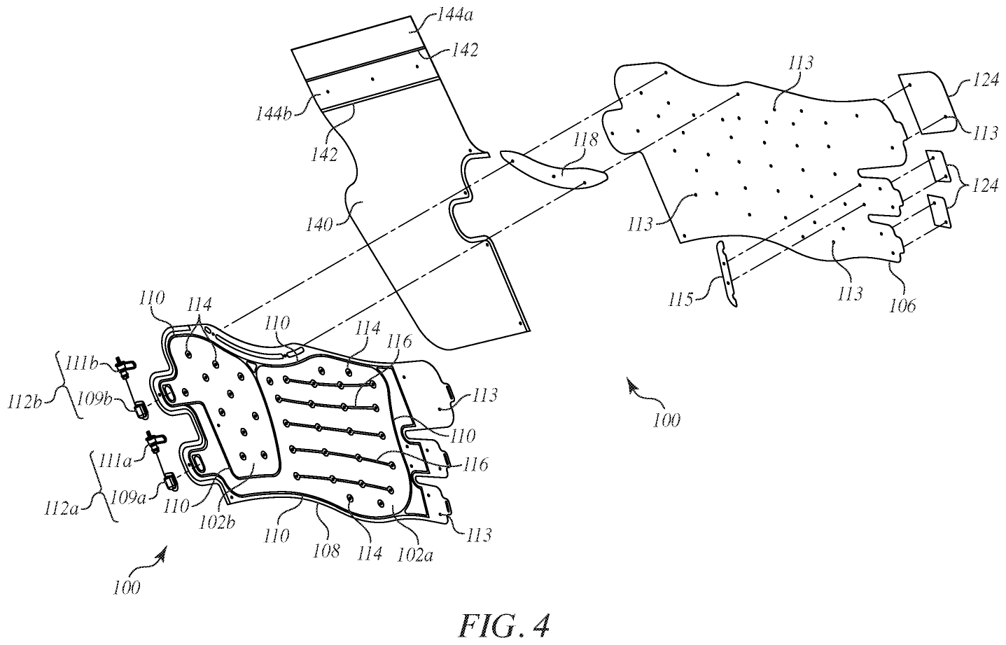

It can be appreciated that depending on the location of the thigh therapeutic compression apparatus, different pressure gradients or compression gradients may be utilized. Looking at FIGS. 4, 5 and 6 other examples of other bladder pressure gradient profiles are described herein. Other possible gradient pressure profiles or compression gradient profiles may be imagined based upon the geometric location of the spot welds 114, 414 alone or in connection with the linear welds 116, 416.

In order to improve comfort, through-holes 113, as seen in FIGS. 1-2, and 4-7, (through-holes 413 as seen in FIGS. 6 and 7) are located throughout thigh therapeutic compression apparatus 100 (400) in order to allow for ventilation about a patient's thigh during extended wear of thigh therapeutic compression apparatus 100 (400). For the sake of clarity, not all of the through-holes 113 (and 413) are identified with reference characters in the Figures.

Referring now to FIGS. 1-5, once thigh therapeutic compression apparatus 100 is secured around a patient's thigh, bladder 102, 102A, 10213 is inflated and not able to shift out of place, thus increasing comfort and reducing fitting issues on the patient. In order to increase the ease of ambulation by a patient, in this exemplary embodiment, the proximal portion (upper edge located closer to the hip and pelvis) of the thigh therapeutic compression apparatus 100 includes a securing means, which is shown in FIGS. 1-5 as a stabilizer 140 so as to stabilize and secure the thigh therapeutic compression apparatus 100 to the thigh of the user and reduce slippage of the thigh therapeutic compression apparatus 100 down towards the knee. Any stabilizing or securing means may be employed such as for instance, and not show, a hip or waist strap can be used. If a strap is used, the strap may be pulled tight against a patient's leg and hip so as to reduce slippage of the thigh therapeutic compression apparatus 100 down the knee and may also improve compression near the hip area of a patient. In this embodiment, the stabilizing means or securing means 140 is comprised of a material that is comfortable to the user, and possibly thin so as to worn either under pants or over pants. The stabilizing mean or securing means 140 is connected to the wrap along the side closest to the lateral bladder portion 102B and from the proximal end to the distal end of the wrap. The stabilizing means or securing means 140 is comprised of cotton, doe skin, leather, rubber, Spandex™ or any other material. The stabilizing means or securing means 140 as shown in FIGS. 1-5 includes a panel 140 and at least two apertures 144A, 144B on the proximal end configured wherein a belt 300 or other securing means can be inserted and then secured around the waist of the individual when in use. In this embodiment of the thigh therapeutic compression apparatus 100, the securing means is a panel 140 which includes at least one aperture 144 or two 144A, 144B, created by a linear 142 weld(s) or other sealing means such as a linear stitch, linear adhesion, linear fold, or the like. The apertures 144A, 14413 are configured, in this embodiment, to allow a belt system 300 to be inserted within one of the apertures 144A, 144B so as to secure the thigh therapeutic compression apparatus 100 to the waist of a patient and to reduce slippage of the thigh therapeutic compression apparatus 100 downward towards the knee.

While only one aperture 144 may be employed (not shown), the configuration including at least two apertures 144A, 14413 is suggested so that each user can adjust the placement of the wrap and inventive thigh therapeutic compression apparatus along the user's thigh given the user's height, length of leg, waist, and the like. Other configurations may also be employed having three or more apertures 144.

In the embodiment shown in FIGS. 1-5, there are two apertures 144A, 144B so that the patient can adjust the location of the thigh therapeutic compression apparatus 100 on the patient's thigh depending on the height of the patient, the length of the patient's waist (for example, does the patient have a long torso or high or low waist), the length of the patient's thigh (for example, does the patient have long or short legs, including a long or short thigh), the width of the patient's waist (for example, is the patient thinner or thicker at the waist), the anatomy of the patient's hips and buttocks (for example, does the patient have a flat buttock or not), and any other anatomical configuration which may affect how the thigh therapeutic compression apparatus 100 would lie on the patient's thigh when in use and inflated. The securing means of the panel 140 of FIGS. 1-5 are shown in use on a user in FIG. 3 including the belt system 300. In use, the patient inserts the belt system 300 into the aperture 144 chosen, either 144A or 144B (or in other embodiments not shown there may be three or more apertures), and loops the belt around the patient's waist, adjusts the length of the belt system 300 via the adjusting means 305, and then cinches or closes the belt such as via a belt buckle 320 and the inserting are 325, as shown in FIG. 3. Again, other securing means may be employed which are not shown such as a waist strap or a hip strap, so as to reduce slippage of the thigh therapeutic compression apparatus 100 downward towards the patient's knee when in use.

The panel 140 as shown in FIGS. 105 may be comprised of a flexible material such as but not limited to nylon, polyurethane, cotton, or other suitable material, or a material such as Spandex. The panel 140 may be connected to the thigh therapeutic compression apparatus 100 by a RF weld, adhesive, glue or any other known connecting means.

While a strap, rope of other securing means may be inserted into the apertures 144A, 144B, in the embodiments shown in FIGS. 1-5, by way of example only and non-limiting, a belt 300 is shown including the belt portion 310, adjusting means 305 to shorten or length then overall belt 300, and a belt closure such as a buckle 320 and inserting portion 315, which belt system 300 is worn by the user at the waist. The belt system 300 may be employed as shown in FIGS. 105, but other securing means or belt systems may be employed such as for example and not limited to hook and loop closure or VELCRO™ or any other known connecting means such as buckles, straps, buttons, snaps, zippers, hooks and other combinations.

In another exemplary embodiment, a hip strap (not shown) or a waist strap (not shown) is configured and adapted to improve wearability of the thigh therapeutic compression apparatus 100 by locating a portion of bladder 102, 102A, 102B, 402 above the widest portion of the thigh of a patient and provides stability of thigh therapeutic compression apparatus 100 by preventing thigh therapeutic compression apparatus 100 from slipping down the thigh of a patient towards the knee, which would make the thigh therapeutic compression apparatus 100 less effective in providing thigh compression.

In accordance with another exemplary embodiment, inner sheet 106, 406 further includes a layer (not shown) that has a first elastic modulus, inner sheet 106, 406 has a second elastic modulus. The first elastic modulus is less than the second elastic modulus in a transverse direction relative to the proximal and distal end portions of therapeutic compression apparatus 100, 400 to wrap thigh therapeutic compression apparatus 100 around the thigh when the air bladder 102, 102A, 102B, 402 is inflated. In an exemplary embodiment, inner sheet 106, 406 includes a secondary sheet (not shown) disposed on an inner surface thereof, to directly contact the thigh in use. The secondary sheet can be a fabric layer, which is elastic in a first direction and inelastic in a second direction to curl the wrap member around the leg when the leg compression bladder is inflated.

It will be appreciated that the chambers of the bladder 102 (102A and 102B) may be filled by air, fluid or other known means of inflation, It will also be appreciated that the bladder 102 (102A and 102B) can be arranged to receive air and be inflated using a manual pumping bulb (as shown in FIG. 3 as 200), or can be inflated by an electric air pump (not shown) which can use batteries or AC wall current to pump air into the chamber(s). Any known source of air or fluid may be employed whether manual, mechanical, electrical, battery-operated or any other power sourced pump or pressure creator. The inflation means 130 may be a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient.

The embodiment of the thigh therapeutic compression apparatus 100 may further (not shown) include an absorbent foam, sponge or dressing to be used alone or with a suction conduit coupled to a suction apparatus. Other embodiments of the compression mechanism are possible such as a combination of a sealed fluid-filled bladder, an absorbent foam, sponge or dressing, and a suction conduit for use with venous ulcers or other open wounds. The absorbent foam, sponge or dressing (not shown and hereinafter referred to as “the sponge”) may have the ability to absorb exudate from the wound or ulcer. In addition, the sponge preferably has an open-cell structure which aids in wicking the exudate from the wound or ulcer. The sponge may be lightly affixed to the patient's skin by an adhesive film such that the sponge may be peeled off and replaced. Some embodiments may include a suction conduit for example provided in between the thigh therapeutic compression apparatus 100 and the sponge. More particularly, the suction conduit may be oriented downwardly towards the sponge so that when a source of negative pressure is applied to the suction conduit, that negative pressure is applied to the wound or ulcer via the sponge. As a result, exudate can be wicked and suctioned away from the wound or ulcer via the sponge and into the conduit (such as a tube and other devices). In one embodiment, the conduit may be easily detached from the thigh therapeutic compression apparatus 100 so that the patient can walk or be transported away from the source of suction while pressure is still being applied to the wound or ulcer.

In another embodiment as seen in FIG. 4, the gap 103 in the lateral bladder 102B (which connects the flow of fluid between 102A and 102B) may be closed off and either the lateral bladder 102B inflated at manufacture to a set pressure level or not inflated and remain in an uninflated state when in use. Also not shown, in another embodiment, the lateral bladder 102B may be closed via a closing means (not shown) such as snap, hook, zipper, or other closing means. In such embodiment, if the lateral bladder 102B is closed or sealed, the lateral bladder 102B may also have a separate inflation means 130′ so that the lateral bladder 102B has a different pressure level than the pressure within the medial bladder 102A. As shown in FIG. 4, the lateral bladder 102B can be separately inflatable or inflatable through a n inflation means 112B including 109A, 111B, such as but not limited to a one-way valve or other desired inflation/deflation configuration. The lateral bladder 102B can also be configured and adapted to provide a differing pressure from the medial bladder 102A.

Hook and loop fasteners 124, 424 are provided along the edge of inner and outer sheets 106, 108 in order to ease adjustment in the embodiments shown in FIGS. 1-5, close up and secure the thigh therapeutic compression apparatus 100 (400) on a patient's thigh. A connector 115 may be used to strengthen the area between then hook and loop fastened 124 to prevent tearing of the material when in constant use by the individual. It is envisioned that thigh therapeutic compression apparatus 100, 400 can also be secured to a patient's thigh by other means, such as zippered, buttoned, or be cuff shaped by other such suitable means. Further, it is also envisioned that hook and loop closures 124 can be replaced by material similar to that of a strap described below and be welded/sewn/attached to bladder 102, 102A (or even 102B) for improved comfort. As shown in FIGS. 1-5, the hook and loop closures 124 can connect to the panel 140 and thus close around the thigh of the individual when in use. Other configurations for closure may be employed.

In one embodiment of the present invention inflation means 130 is a hand pump 200 which can attach to inflation port 112, 412 to inflate bladder 102, 102A, 102B, 402. It can be appreciated that a mechanical or automatic inflation pump (not shown) can also be attached to inflation port 112, 412 to inflate and deflate bladder 102, 102A, 102B, 402 to provide pulsating pressure to a user's thigh. A number or variety of inflation means can be employed not limited to a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. A vent valve is also be incorporated into thigh therapeutic compression apparatus 100, 400 or with inflation means 130 to allow a user to selectively deflate bladder 102, 102A, 102B, 402. Further, a relief valve is also incorporated with either inflation means 130 or bladder 102, 102A, 102B, 402 to prevent over inflation once a maximum pressure is detected. Examples of relief valves are described in U.S. Pat. Nos. 7,276,037 and 7,850,629, the disclosures of which are incorporated by reference in their entirety.

In another embodiment of the present invention the therapeutic compression apparatus 100, 400 can be formed by first forming bladder 102, 102A, 102B, 402 to be integral within inner sheet 106, 406 and outer sheet 108, 408, the location and desired preconfigured compression gradient profile can be obtained cost-effectively. A number of different embodiments of bladder configurations can be used in the thigh therapeutic compression apparatus 100, 400 of the subject invention such as those configurations described above. In another embodiment thigh therapeutic compression apparatus 100, 400 may have a bladder 102, 102A, 102B, 402 with a plurality of spot welds 114, 414 therein. Spot welds 114, 414 may be strategically placed within bladder 102, 102A, 102B, 402 in a predetermined pattern based on the desired gradient profile relative to the compression needed at the patient's treatment site. Spot welds 114, 414 enable bladder 102, 102A, 102B, 402 to define the gradient profile when inflated through inflation port 112, 412. The geometric placement of spot welds 114, 414 within bladder 102, 102A, 102B, 402 allows increased inflation of certain portions of bladder 102, 102A, 102B, 402, and can create one or more fluid chambers within bladder 102, 102A, 102B, 402. This configuration is particularly useful when compression is needed to improve fluid movement (e.g., blood, lymph, etc.) within the body. Further, linear weld lines 116, 416 allow for better compression along the thigh of the patient calf by increasing tension applied to a certain portion of the thigh of the patient, such as the inner thigh or the outer thigh, depending on the treatment considered for such patient. This increased tension can generate a more effective thigh compression in order to increase venous flow. For instance, in the exemplified and embodiments shown in FIGS. 1-2, and 4-5, the linear weld lines 116 are only within the medial bladder 102A and thus, their geometric pattern together with the geometric pattern of the spot welds 114 form a gradient pressure profile or gradient compression profile for the inner thigh area of the patient when inflated. Other configurations may be employed, whereas the spot welds 114 are in other geometric shapes or patterns and therefore create other gradient compression profiles for the bladder 102 when inflated and in use. As shown in FIGS. 1-2 and 4-5, the spot welds 114 of the lateral bladder 102B are in a geometric shape or pattern create a different or the same gradient pressure within the lateral bladder 102B compared with the medial bladder 102A. Any geometric pattern may be employed to create the set gradient compression profile and level within the bladder 102 when inflated and in use. As shown in FIGS. 1-2 and 4-5, one gradient compression profile is shown including linear weld lines 116 are located along the inner thigh and further create a ribbed portion, which keeps the inflated profile of therapeutic compression apparatus 100 compact which can further increase ambulation and reduce interference with a patient's clothes.

It can be appreciated that depending on the location of the therapeutic compression apparatus being placed on the patient's body part or limb, different compression gradient profiles may be utilized. Further, different pressure gradients may be employed depending on the treatment (general swelling, lactic acid build up, lymphedema, post-sclerotherapy, CVT, DVT, etc.) and the treatment site. Examples of other bladder compression gradient profiles are described in FIGS. 6-7. Other examples of bladder compression gradient profiles are described in U.S. patent application Ser. No. 12/911,563 and U.S. patent application Ser. No. 12/855,185, the disclosures of which are incorporated by reference in their entirety.

A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. Further, the inflation means could include a means to monitor or regulate the inflation. The inflation means could include programming such that the bladder 102, 102A, 102B, 402 is inflated and deflated to a set pressure at intervals or at set times throughout the day or night when the compression apparatus is in use worn on the patient. For instance, by way of example only, the inflation means could be set to 40 mm-Hg at 9 am and then set to deflate to 20 mm-Hg at 11 am and then set to inflate to 30 mm-Hg at 12 pm and so on throughout the day and night for each patient individually. In another embodiment of the present invention, if the lateral bladder 102B is sealed and separate from the medial bladder 102A, then there may be two separate inflation ports 112 (e.g. 112 A and 112B) that are each connected to either the same or different inflation means, and the pressure levels of the medial bladder 102A and the lateral bladder 102B could be the same or have different pressure levels. For instance, by way of example only, the inflation means could be set to 40 mm-Hg for the medial bladder and set to 20 mm-Hg for the lateral bladder, or each could vary and the inflation means be set to inflate, deflate, inflate, etc. throughout the day as described above.

It is envisioned, that the inventive thigh therapeutic compression apparatus (either 100 or 400) could be used in conjunction with a lower leg compression apparatus (such as those described in U.S. Pat. Nos. 9,033,906 and 7,967,766 and 7,559,908 and 7,276,037 and U.S. Ser. No. 13,444,600), and one inflation means could be connected to each of the two compression apparatus. The inflation means could include programming such that the bladders of both the thigh therapeutic compression apparatus and the bladder or bladders of the lower leg compression apparatus are each(or together at the same time) inflated and deflated to a set pressure at intervals or at set times throughout the day or night when the compression apparatus is in use worn on the patient. For instance, by way of example only, the inflation means could be set to 40 mm-Hg at 9 am and then set to deflate to 20 mm-Hg at 11 am and then set to inflate to 30 mm-Hg at 12 pm and so on throughout the day and night for each patient individually. In another embodiment of the present invention, for instance, by way of example only, the inflation means could be set to 40 mm-Hg for the thigh bladder and set to 20 mm-Hg for the lower leg bladder (or calf bladder or foot bladder, etc.), or each could vary and the inflation means be set to inflate, deflate, inflate, etc. throughout the day as described above. Depending on the treatment plan for the patient and depending on the specific patient, each of the bladders could be set to the same or different pressure levels though out the day and night.

In one embodiment of the invention, the inflation means includes a manual hand pump 200 (as shown in FIG. 3) and the dial includes graphics of pressure amount such as “35, “45′, “55′ and “65” or lettering such as “A”, “B”, “C”, “D” which each would correspond to a certain pressure such as 25 mm-Hg, 35 mm-Hg, 45 mm-Hg and 55 mm-Hg. The specific pre-determined pressure to correspond with the graphic is endless and not limited by the examples herein.

Further, the therapeutic compression apparatus may be deflated by a valve cap or in another embodiment has a button or a switch to deflate the bladder 102, 102A, 102B, 402 and thus release the pressure. In another embodiment (not shown), the switch may have a plurality of integrated umbrella valves so that one umbrella valve is set and closed to maintain the pressure within the bladder 102, 102A, 102B, 402, while a second umbrella valve would release a certain amount of air or fluid within the bladder 102, 102A, 102B, 402, so as to release the pressure such as while the patient is walking (pressure increases on the thigh with each step) or flying (pressure increases based on altitude), and a thirds umbrella valve which would release all the air or fluid in the bladder 102, 102A, 102B, 402 and thus release all pressure and deflate the thigh therapeutic compression apparatus 100 or 400. For instance by way of example only, the first umbrella valve is set in a closed position so that when activated this umbrella valve maintains the amount of air or fluid in the bladder 102, 102A, 102B, 402 and thus maintains the set pressure, say for instance at 45 mm-Hg, the second umbrella valve is set to release the air or fluid within the bladder 102, 102A, 102B, 402 if the pressure within exceeds 45 mm-Hg and bring the pressure down to 45 mm-Hg (such as when in high altitude or other increases in pressure) and then maintain the pressure at 45 mm-Hg, and a third umbrella valve is set to open and release all the air or fluid within the bladder 102, 102A, 102B, 402 and thus release all pressure when activated by the patient so as to deflate the bladder 102, 102A, 102B, 402 and the therapeutic compression apparatus 100, 400. By way of another example, the dial may include graphics such as (A) “Walk” wherein the set pressure amount is maintained while the patient walks and the pressure spikes and returns over and over in time as the umbrella valve remains in the closed position, (B) then a graphic of “Air” wherein the set pressure amount will be maintained by this umbrella vale occasionally releasing pressure as the pressure increases over the set amount or value so that the umbrella valve is activated to release air or fluid within the bladder 102, 102A, 102B, 402 and release the pressure yet then close and stay closed to maintain the set pressure amount, and (C) “Release” or “Deflate” wherein the pressure will be released and the air or fluid within the bladder 102, 102A, 102B, 402 released to deflate and this umbrella valve is always in the open position. In this embodiment (not shown) there are three umbrella valves with one set to always open the bladder 102, 102A, 102B, 402 to release pressure completely, one set to always close to maintain air or fluid in the bladder 102, 102A, 102B, 402 to maintain pressure, and a third set to open or release at a predetermined or set pressure point. In all of the embodiments referring to umbrella valve the umbrella valve may also be a switch (manual or otherwise) or a digital switch or any other known means to open, close or partial release air or fluid within a bladder and thereby maintain, change or release pressure therein.

The inflation means and valves shown in FIGS. 1-7 include an inflation port 112 or 412 having an elbow connector 109, 409 which is welded to the thigh therapeutic compression apparatus 100, 400 to allow air to flow into it. A check valve or relief valve is inserted into the elbow connector 109, 409. A dust cap or valve cap 111, 411 is included to prevent dust clogging the check valve and if inserted in a reverse configuration the inflated bladder is deflated manually. This is spring loaded so that the inflation means can inflate the bladder 102, 102A, 102B, 402 and once the inflation means is removed the spring seals the bladder 102, 102A, 102B, 402 such that the pressure is not released until manually or automatically decreased or deflated. The check valve may also be non-spring activated and activated by any other known means. The inflation means may include a bulb, motorized, batter-operated or electric means. The inflation means may include the dials shown or a simpler dial or one valve. Further embodiment are envisioned but not shown.

The inflation means 130 shown in FIG. 3 includes a hand pump 200 including a tube connected to a pump assembly including a valve dial and in this embodiment three umbrella valves, as well as a label which the user can use to see the various pressure amounts for the thigh therapeutic compression apparatus 100. The hand pump bulb 200 may be a squeeze bulb or any other known hand pump or ball.

In another embodiment of the present invention the compression apparatus may be a stand-alone thigh compression or thigh compression portion added to the leg and foot compression apparatus of the various other disclosed embodiments. The thigh compression apparatus includes an inner layer and an outer layer. The outer layer has joined to it an inflation port which is capable of connecting or joining to an inflation means. The inner layer includes a plurality of fasteners. In one embodiment the thigh compression apparatus includes, by way of example only, hook and loop fasteners along the edge to ease adjustment and secure therapeutic compression apparatus on a patient's thigh. Other uses of the thigh compression apparatus may be used such as on the back, calf, arm, stomach, torso, shoulder and other body parts, such that the designation as the “thigh” compression apparatus is not limited to only use of such apparatus on the thigh of a patient. It is envisioned that compression apparatus can also be secured to a patient's thigh or other body part by other means, such as zippered, buttoned, or be cuff shaped by other such suitable means.

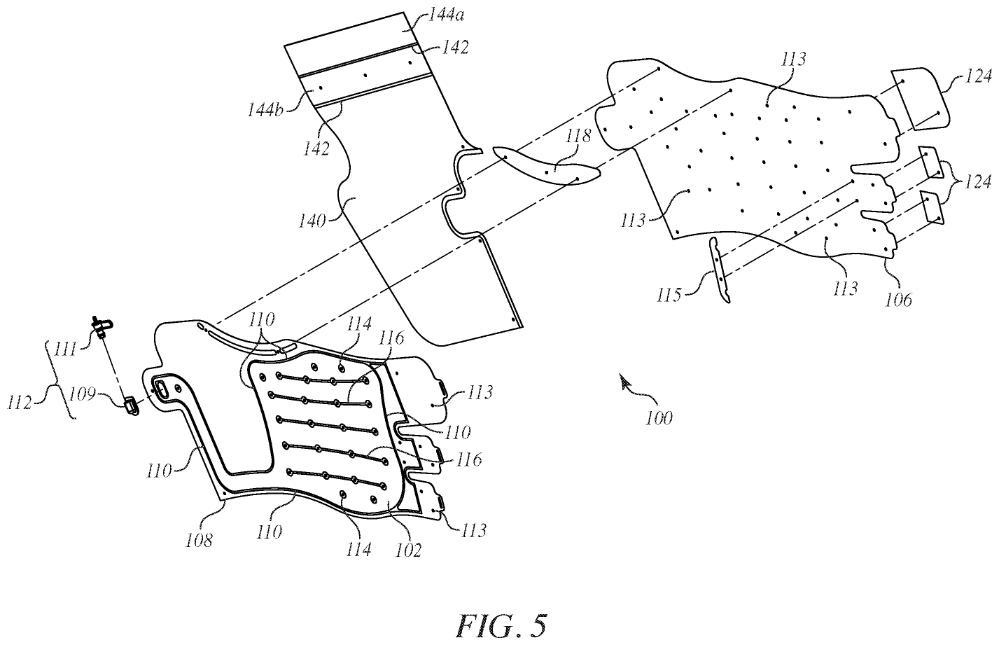

Post-operative sclerotherapy treatment can also be effective with thigh therapeutic compression apparatus 100 wherein the lateral bladder 102B is closed via a closing means (not shown) over the gap 103 and either remains in a non-inflated state or may be slightly inflated to a lower pressure level, or could be inflated to any pressure level desire by the patient. As shown in FIGS. 4, the lateral bladder 102B is separate and not connected to the medial bladder and thus in this embodiment, the medial bladder 102A is inflated as part of the post-operative treatment plan to apply a certain predetermined gradient compression profile and pressure to the treatment site while a different predetermined gradient compression profile and pressure may be applied to the back or lateral portion of the user's thigh. Looking at the embodiment shown in FIG. 5 including only one bladder which is the medial bladder 102A, the predetermined gradient compression profile and pressure would be applied via the medial bladder 102A and the only compression applied to the remainder of the thigh would be the wrap itself closed on the thigh as the thigh therapeutic compression apparatus would not include a lateral bladder 102B. In another embodiment of the present invention, the thigh therapeutic compression apparatus 100 as shown in FIG. 5, only one bladder 102A is shown and configured to be compressed against the medial portion of the patient's leg on the inner thigh area. No lateral bladder (102B) in included in this embodiment of the present invention. This embodiment may be used in post-operative sclerotherapy treatment along with other treatments and post-operative treatments, Typically varicose veins are located on the inner thighs of an individual patient and for post-operative sclerotherapy treatment, compression is needed on the surgical site along the inner thigh. The embodiment of the inventive thigh therapeutic compression apparatus 100 as shown in FIG. 5 can be used for specific compression only along the inner thigh of the patient's leg, such as post-operative sclerotherapy procedures. Other post-operative procedures may employ the same method.

Other treatments such as lymphedema may employ both the medial bladder 102A and the lateral bladder 102B in an inflated state so as to apply compression and pressure to the selected site on the patient's thigh. As described above, the bladders 102A, 1022B could have the same pressure level, or if closed and separated with separate inflation ports 112 (112A and 112B respectively as shown in FIG. 4) have different pressure levels.

Referring now to FIGS. 6-7, another embodiment of the inventive thigh therapeutic apparatus 400 is shown, including bladder 402 (102A and 102B) integral within inner sheet 406 and outer sheet 408, the location and desired preconfigured compression gradient profile can be obtained cost-effectively. Continuous peripheral weld line 410 forms an airtight boundary of integrally formed bladder 4 02.A number of different embodiments of bladder configurations can be used in the thigh therapeutic compression apparatus 400 of the subject invention and which include a plurality of spot welds 414 and linear weld lines 116therein. Spot welds 414 are strategically placed within bladder 402 in a predetermined pattern based on the desired gradient compression profile relative to the compression needed at the patient's treatment site. Spot welds 414 enable bladder 402 to define the gradient profile when inflated through inflation port 412. The geometric placement of spot welds 414 within bladder 402 allows increased inflation of certain portions of bladder 402, and can create one or more fluid chambers within bladder 402, in this embodiment fluid chambers are further defined by the vertical linear weld lines 416. This configuration is particularly useful when compression is needed to improve fluid movement (e.g., blood, lymph, etc.) within the body. Further, linear weld lines 416 allow for better compression along the inner though and outer thigh of a patient's thigh by increasing tension applied to the medial portion of the thigh of a patient and thus further forming the predetermined S gradient compression profile. This increased tension can generate a more effective thigh compression in order to increase venous flow. Linear weld lines 416 located vertically along the medial portion of the thigh create a ribbed portion, which keeps the inflated profile of therapeutic compression apparatus 400 compact which can further increase ambulation and reduce interference with a patient's clothes whether worn under or on top of the patient's clothes such as pants.

Referring now to FIGS. 6-7, once thigh therapeutic compression apparatus 100 is secured around a patient's thigh, bladder 402 is inflated and not able to shift out of place, thus increasing comfort and reducing fitting issues on the patient. In order to increase the ease of ambulation by a patient, in this exemplary embodiment, the proximal portion (upper edge located closer to the hip and pelvis) of the thigh therapeutic compression apparatus 400 includes a securing means, which is shown in FIGS. 6 and 7 as a series of apertures 425 on the proximal end which are configured to allow a hook, snap, strap, or other material to be placed therein so as to secure the thigh therapeutic compression apparatus 400 to the thigh of the user and reduce slippage of the thigh therapeutic compression apparatus 400 down towards the knee. Any securing means may be employed such as for instance, and not show, a hip or waist strap can be used. If a strap is used, the strap may be pulled tight against a patient's leg and hip so as to reduce slippage of the thigh therapeutic compression apparatus 400 down the knee and may also improve compression near the hip area of a patient. In this embodiment, the securing means may include the apertures 425 which are connected to a strap 523 having a hook 519, which strap and hook are inserted within an aperture 425 and then snapped together. In this embodiment as shown in FIG. 7, a garter belt system 300, by way of example only and non-limiting, has a belt 310 and a belt closure such as a buckle 320 which belt system 300 is worn by the user at the waist. The belt system 300 includes the strap 523 and other connecting means such as a hook 519, though other connecting means may be employed such as for example and not limited to hook and loop closure or VELCRO™ or any other known connecting means such as buckles, straps, buttons, snaps, zippers, hooks and other combinations.

The thigh therapeutic compression apparatus 400 includes a panel 418 located along the proximal end portion of the thigh therapeutic compression apparatus configured to conform to the groin area of the leg. The panel 418 may be comprised of a flexible material such as but not limited to nylon, polyurethane, cotton, or other suitable material, or a material such as Spandex. The panel 418 may be configured to prevent the occurrence of a pinch point and reduce pressure on a patient's groin area when wearing the thigh therapeutic compression apparatus 400.

The thigh therapeutic compression apparatus may include an optional knee pad 420 which may be separate or connected to the thigh therapeutic compression apparatus 400. As shown in FIGS. 6-7, the optional knee pad 420 is connected to the thigh therapeutic compression apparatus 400 though a connecting means of 421A located on the optional knee pad 420 to an aperture of other married connecting means 421B located on the thigh therapeutic compression apparatus 400. Any other connecting means may be employed such as but not limited to hook and loop closure or VELCRO™ or any other known connecting means such as buckles, straps, buttons, snaps, zippers and other combination. In the alternative the connecting means 421A and 421B may be welded together or adhered or other connecting manner. The optional knee pad 420 may be comprised of a flexible material such as but not limited to nylon, polyurethane, cotton, or other suitable material, or a material such as Spandex.

In accordance with another exemplary embodiment of the thigh therapeutic compression apparatus 400 of FIGS. 6-7, inner sheet 406 further includes a layer (not shown) that has a first elastic modulus, inner sheet 406 has a second elastic modulus. The first elastic modulus is less than the second elastic modulus in a transverse direction relative to the proximal and distal end portions of therapeutic compression apparatus 400 to wrap therapeutic compression apparatus 100 around the leg when the leg compression bladder is inflated. In an exemplary embodiment, inner sheet 406 includes a secondary sheet (not shown) disposed on an inner surface thereof, to directly contact the lower leg in use. The secondary sheet can be a fabric layer, which is elastic in a first direction and inelastic in a second direction to curl the wrap member around the leg when the leg compression bladder is inflated.

In another exemplary embodiment of the thigh therapeutic compression apparatus 400 of FIGS. 6-7, a hip strap (not shown) or a waist strap (not shown) is configured and adapted to improve wearability of therapeutic compression apparatus 400 by locating a portion of bladder 402 above the widest portion of the thigh of a patient and provides stability of thigh therapeutic compression apparatus 400 by preventing thigh therapeutic compression apparatus 100 from slipping down the thigh of a patient towards the knee, which would make the thigh therapeutic compression apparatus 400 less effective in providing thigh compression.

The embodiment of the thigh therapeutic compression apparatus 400 in FIGS. 6-7 may further (now shown) include an absorbent foam, sponge or dressing to be used alone or with a suction conduit coupled to a suction apparatus. Other embodiments of the compression mechanism are possible such as a combination of a sealed fluid-filled bladder, an absorbent foam, sponge or dressing, and a suction conduit for use with venous ulcers or other open wounds. The absorbent foam, sponge or dressing (not shown and hereinafter referred to as “the sponge”) may have the ability to absorb exudate from the wound or ulcer. In addition, the sponge preferably has an open-cell structure which aids in wicking the exudate from the wound or ulcer. The sponge may be lightly affixed to the patient's skin by an adhesive film such that the sponge may be peeled off and replaced. Some embodiments may include a suction conduit for example provided in between the thigh therapeutic compression apparatus 400 and the sponge. More particularly, the suction conduit may be oriented downwardly towards the sponge so that when a source of negative pressure is applied to the suction conduit, that negative pressure is applied to the wound or ulcer via the sponge. As a result, exudate can be wicked and suctioned away from the wound or ulcer via the sponge and into the conduit (such as a tube and other devices). In one embodiment, the conduit may be easily detached from the thigh therapeutic compression apparatus 400 so that the patient can walk or be transported away from the source of suction while pressure is still being applied to the wound or ulcer.

The inventive thigh therapeutic compression apparatus 100, 400 may be included in a kit having various wound dressings and/or bandages. The wound dressings and/or bandages may be disposed of on a more frequent basis and the inventive therapeutic compression apparatus is applied in conjunction or combination with the wound dressings and/or bandages. In one embodiment the therapeutic compression apparatus is used over or on top of the wound dressing applied to the skin.

Another embodiment of the present invention includes a method of applying a measured compression amount with feedback. In this embodiment (not shown), Compression Bladder A is inflated by Inflation Source C—the nature of Compression Bladder A is such that the amount of compression is determined by the amount of inflation medium (typically air) pumped into A from C. In this design, Inflation Source C is also coupled with Bladder B, which has a fixed volume of air. When Compression Bladder A inflates, it will squeeze Bladder B as it compresses Compressed Item F. Inflation Source C is able to read the line pressure from the Coupling Line E to determine the interface pressure from Bladder B—in this design, Inflation Source C can be calibrated to provide only the amount of inflation medium necessary into Compression Bladder A as determined by matching the desired interface pressure from Bladder B. Other configurations may be employed so that feedback may be obtained from the inflation means and compression apparatus.

Another embodiment of the present invention includes a Sequential Gradient Compression with Single Chamber. In such embodiment (not shown), the compression apparatus includes an inflation bladder to apply not only gradient compression but sequential (filling up either the medial bladder 102A first and then filling up the lateral bladder 102B second, or the opposite) compression. In this embodiment (not shown), Inflation Device A is coupled to the device in two places (Intake Port C and Exhaust Port D). By inflating and providing air that goes directly into Channel B, the First Bladder Portion E (either the medial bladder 102A or the lateral bladder 102B as chosen by the patient) inflates first, before the Second Bladder F (the opposite bladder of First Bladder Portion E, so either the lateral bladder 102B or the medial bladder 102A). Air Then exits out of Exhaust Port D. In this design, the inflation can be intermittently provided for gradient and sequential compression or inflation can be held at a constant level to provide just the gradient profile.

Another embodiment of the present invention include an electric or other automated inflation means such that the bladder is inflated to a set volume or by reading the back pressure of which is being filled in. A pressure cycling function may be included. Further, an embodiment may have an inflation means such that the inflation maintains in the bladder(s) even after the inflation means is removed. Such inflation means may be integral to the compression apparatus itself or may be removable. Such inflation means may include an integrated circuit and/or wireless capability for tracking of usage, pressure, compliance by the patient in regard to maintaining certain pressures recommend by a physician or part of such patient's treatment plan, and other health data such as standing pressure and moving or working pressure, pedometer (number of steps), heartbeat, blood pressure and any other possible monitoring of the patient. Depending on the feedback obtained the inflation means may be programmed to increase or decrease the pressure without manual changing by the patient. Further, the inflation means may be configured so that the physician or other treatment professional may increase or decrease the pressure remotely based on the feedback. Other combinations may be included such as manual changing of the dial or inflation means in combination with automated means or electric means or digital means.

The dials shown are non-digital by way of non-limiting example only but a digital means may also be employed. A motorized pump and digital display may be used. The valve may include digital or electric means to change or modify pressure at a set rate or intervals or based on feedback from the monitoring means. The apparatus may include various sensors and monitors

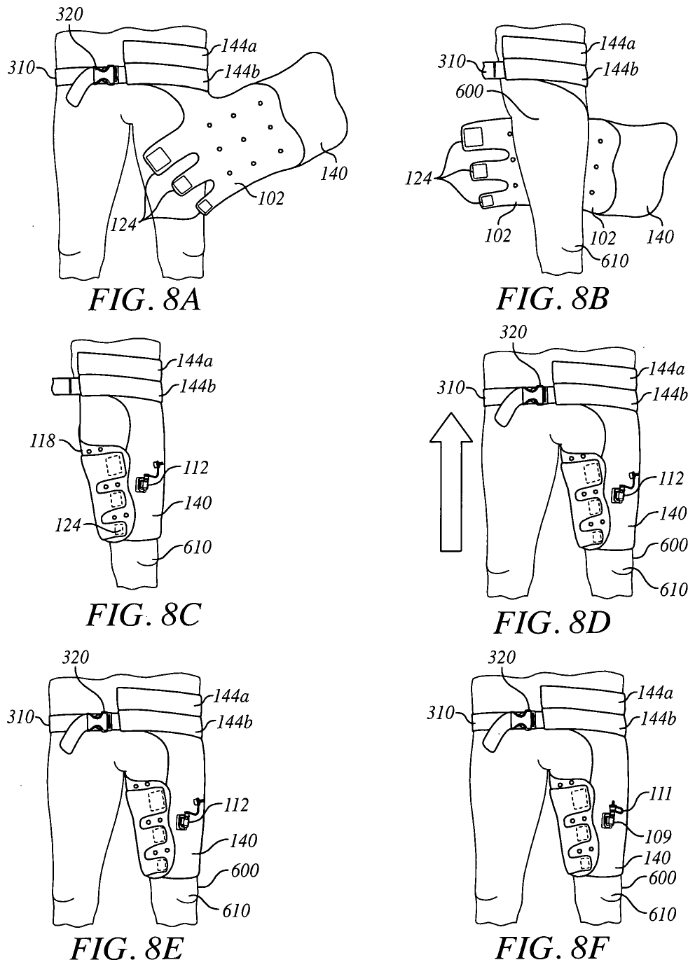

In use the therapeutic compression apparatus 100 or 400 may be placed by the patient, practioner or care-giver on the chosen limb, such as for instance the thigh and fastened around the thigh of the patient. FIGS. 8A-8F shows one flow representations of the method of use of the thigh therapeutic compression apparatus 100 though other methods may be envisioned but not shown here. The user places the belt system 300 through the aperture either 144A or 144B depending on the individual's height and thigh location, then adjusts the belt 310 via the adjusting means 305 and buckles snaps or otherwise stabilizes and secures the thigh compression apparatus 100 to the waist and hip area of the individual. As seen in FIG. 8B, the user then places the lateral bladder 102B behind the thigh area such the medial bladder 102A is located on the inner thigh area and the hook and loop fasteners 124 are located on the outer thigh area, with the distal end of the therapeutic thigh compression apparatus 100 located above the knee 610 on the thigh 600. The user then closes or secures or fastens the therapeutic thigh compression apparatus 100 on the thigh 600 and locates the panel 118 and places it along the groin are of the upper thigh 600. The user then adjusts the therapeutic thigh compression apparatus 100 upward on the thigh 600 as seen in FIG. 8D. Moving in an upward or downward position from the knee 610 and/or hip then the patient, practioner or care-giver fastens or secures the fastening tabs (such as 124 or 424) up or down to the knee as seen in FIG. 8E. If there are additional optional straps located on the proximal end of the apparatus the first strap should be closed or secured in a tight fashion so that the therapeutic compression apparatus fits snugly but not too tight and the second strap should be closed or secured in a tight fashion so that the therapeutic compression apparatus fits snugly but not too tight. The patient, practioner or care-giver then removes the valve cap 111 from the valve located on the therapeutic compression apparatus. The patient, practioner or care-giver then selects a pressure amount of value on the dial of the inflation means depending on the treatment and whether the patient will be walking, sitting, lying down or traveling in a vehicle, train or airplane. Once the pressure amount or value is chosen on the dial (such as a given pressure amount such as “35” mm-Hg or a text such as “Walk” or “Air” or “Travel” or “Low” or “Medium” or “High”), the corresponding umbrella valve or switch is activated such that the pressure is thereafter maintained (closed position) or modified so as to maintain the pressure as it changes with the activity or altitude when in use). The patient, practioner or care-giver then inserts an end of the inflation means into the valve on the therapeutic compression apparatus and the air or fluid is increased to inflate the bladder (102, 102A, 102B, 402) and thus achieve a desired pressure amount or valve. Again this inflation means may be a hand pump, electric pump, battery-operated pump, remote controlled pump, air pump, gas pump, or any other known inflation means. A number or variety of inflation means can be employed such as a manual pump, hand pump, foot pump, mechanical pump, electrical pump, battery-operated pump, static pump, intermittent pump, varying pump, automatic pump, pneumatic pump, negative pressure pump, suction pump or vacuum, pulsing pump, or any other known or developed source of inflation so as to provide a certain pressure within the bladder so to provide compression in use by the patient. The valve cap 111 is then placed in the elbow connector 109 of the inflation port 112. Depending on the inflation means employed such inflation means may be removed and the valve cap replaced and the pressure will not decrease except as noted in the “Air” or “Walk” position. At any point in use the patient, practioner or care-giver can deflate the bladder by either inserting the valve cap so it depresses the valve spring and thus release the air or fluid in the bladder and decrease the pressure, or the patient, practioner or care-giver can reinsert the inflation means and select the “Deflate” or “Release” and the corresponding umbrella valve will be in the open position so as to release the air or fluid in the bladder and decrease the pressure until a deflated state is achieved for the bladder and the therapeutic compression apparatus. The therapeutic compression apparatus can be reinflated and deflated over and over again when in use.

The present invention has been illustrated and described with respect to specific embodiments thereof, which embodiments are exemplary and illustrative of the principles of the invention and are not intended to be exclusive or otherwise limiting embodiments. For instance, while in the foregoing embodiments the therapeutic compression apparatus are described as having inflatable bladders, the therapeutic compression apparatus may additionally include integrally formed or attached (e.g., by adhesive, radio-frequency welding, etc.) compression members that are not configured for inflation and/or deflation. For instance, additional compression members may be implemented using any of a variety of preformed and/or prefilled cushioning materials such as foam cushions and/or air, gel, or other fluid filled non-inflatable cushions, provided such compression members generate sufficient compression in combination with integral compression bladders. Further, while particular shapes, sizes, and materials have been described for purposes of illustration, it will be recognized that any of a variety of shape or size can be used, and the materials described are not exclusive but merely illustrative. Also, as noted above, while the bladder shown is inflated with air, it will be appreciated that any other fluid or medium such as liquid or gel can be used. Moreover, as also noted, it will be understood that bladders may be configured to have multiple pneumatically independent and/or pneumatically coupled bladder sections, and may also be configured to have various contours or lobulations.

The thigh therapeutic compression apparatus described herein can be used for any suitable condition treatable by compression therapy and the like. For example, therapeutic compression apparatus in accordance with the present invention can be used for compression of the venous system for the treatment of venous ulcers, CVI, DVT, for the treatment of lymphedema (where it is circulation of fluids in the lymph system rather than in the venous system that is promoted), and the like.

The thigh therapeutic compression apparatus of the instant invention described herein solves many problems with the prior art and in the industry and treatment of patients. The therapeutic compression apparatus may be applied on the patient's body part by the patient without the need or requirement of a skilled care-giver as required by current devices and apparatus. It further is capable of maintaining sufficient effective pressure without overpressure complications, maintaining compression and the like.

The thigh therapeutic compression apparatus of the instant invention includes a universal inflation port which is configured to be capable of connecting to more than one source of compression or inflation means such that the patient could vary treatment through varying the inflation source and inflation means for the treatment apparatus or device. For instance, a patient using the thigh therapeutic compression apparatus of the instant invention can alternate between a manual or mechanical or electrical inflation means or source of inflation and pressure. Further, the patient can alternate between static or intermittent inflation and pressure when using the inventive therapeutic compression apparatus

The thigh therapeutic compression apparatus of the instant invention also reduces the problem is leakage of set compression within the treatment apparatus and devices, bandages, stockings and hosiery and instead promotes a more effective treatment for CVI, DVT and/or lymphedema and other treatments. The thigh therapeutic compression apparatus of the instant invention also reduces the problem of slippage downward towards the knee of the patient when the apparatus is in use, especially when the patient is walking or moving about.

The present invention may assist in treatments wherein compression on the long saphenous vein may be recommended in treatment of certain conditions. Other embodiments of the present invention may assist in treatments for other conditions there may be less compression recommendation on the long saphenous vein on the medial side of the leg and more compression recommended on the short saphenous vein of the leg which runs on the back portion of the leg, including the thigh. In other embodiments of the present invention with only one lateral bladder and no medial bladder, the inventive therapeutic compression apparatus may assist in treatment of conditions where compression is recommended only on the short saphenous vein of the leg. These and other needs are met by the inventive thigh therapeutic compression apparatus 100, 400.

Another embodiment (not shown) may be a full leg compression apparatus including a thigh bladder, a calf bladder, an optional foot bladder, and a knee opening (or an optional knee pad) and an optional heel opening and foot strap. In this configuration, the thigh bladder may extend below the knee joint level and apply compression around the patella of the knee area. It may also have suspender hooks or slots (not shown) that allow for suspenders to be mated thereto in order to support the apparatus by a waist band when in use. The suspenders limit downward travel of the apparatus when in use such that it maintains its desired position.

While the subject invention of the present disclosure has been described with respect to preferred and exemplary embodiments, those skilled in the art will readily appreciate that various changes and/or modifications can be made to the invention without departing from the spirit or scope of the invention as described herein. There have been described and illustrated herein several embodiments of an intermittent pressure apparatus and a method of installing and operating same. While particular embodiments of the invention have been described, it is not intended that the invention be limited thereto, as it is intended that the invention be as broad in scope as the art will allow and that the specification be read likewise. Thus, while particular shapes and sizes of inflatable bladders and straps have been disclosed, it will be appreciated that other shapes, sizes, and attachment means may be used as well. It will also be understood that while Velcro and adhesive means have been disclosed for helping to secure the bladders to the leg and foot, other types of attachments such as hooks, snaps, or wraps may be used. In addition, it will be appreciated that while the fluid conduit may be detachably connected to the bladders using mating threaded portions or bayonet locks, other means of attachment known in the art may be used. It will therefore be appreciated by those skilled in the art that yet other modifications could be made to the provided invention without deviating from its spirit and scope as claimed.

We claim:

1. A therapeutic compression apparatus for applying pressure to a thigh of the human body, comprising:
a wrap including at least one bladder configured to be located along the medial area of the thigh and the at least one bladder having a number of welds forming a predetermined compression gradient when inflated;
a first means for locating the at least one bladder along the medial area of the thigh above a knee of the human body when in use;
a second means for locating the wrap along a groin and hip area of the human body when in use;
an inflation means connected to the at least one bladder via an inflation port wherein the inflation means includes a check valve; and
wherein the inflation port is configured to be universally capable of connection to a variety of inflation means.

2. The therapeutic compression apparatus of claim 1, wherein the first means for locating is a first attachment member wrapping around the thigh to secure the wrap to the thigh.

3. The therapeutic compression apparatus of claim 2, wherein the first attachment member is a plurality of straps attached to the wrap.

4. The therapeutic compression apparatus of claim 1, wherein the second means for locating is a second attachment member wrapping around the groin and hip and attached to a securing means around a waist of the human body when in use.

5. The therapeutic compression apparatus of claim 4 wherein the second attachment member is a panel attached to the wrap and extending above a proximal end of the wrap, including at least one aperture on a proximal end of the panel configured to be capable of insertion of the securing means around the waist.

6. The therapeutic compression apparatus of claim 4, wherein the securing means includes a belt or straps for securing around the waist.

7. The therapeutic compression apparatus of claim 1 wherein the at least one bladder has at extend below the knee joint level and apply compression around the patella of the knee area. It may also have suspender hooks or slots (not shown) that allow for suspenders to be mated thereto in order to support the apparatus by a waist band when in use. The suspenders limit downward travel of the apparatus when in use such that it maintains its desired position.
While the subject invention of the present disclosure has been described with respect to preferred and exemplary embodiments, those skilled in the art will readily appreciate that various changes and/or modifications can be made to the invention without departing from the spirit or scope of the invention as described herein. There have been described and illustrated herein several embodiments of an intermittent pressure apparatus and a method of installing and operating same. While particular embodiments of the invention have been described, it is not intended that the invention be limited thereto, as it is intended that the invention be as broad in scope as the art will allow and that the specification be read likewise. Thus, while particular shapes and sizes of inflatable bladders and straps have been disclosed, it will be appreciated that other shapes, sizes, and attachment means may be used as well. It will also be understood that while Velcro and adhesive means have been disclosed for helping to secure the bladders to the leg and foot, other types of attachments such as hooks, snaps, or wraps may be used. In addition, it will be appreciated that while the fluid conduit may be detachably connected to the bladders using mating threaded portions or bayonet locks, other means of attachment known in the art may be used. It will therefore be appreciated by those skilled in the art that yet other modifications could be made to the provided invention without deviating from its spirit and scope as claimed. least two chambers configured wherein one chamber is located along the medial area of the thigh and a second chamber is located along a lateral area of the thigh.

8. The therapeutic compression apparatus of claim 7, wherein the at least two chambers of the at least one bladder are configured such that when the fluid is forced out of one chamber is applies an extra pressure to the other chamber and wherein the predetermined compression profiles are difference in each chamber.

9. The therapeutic compression apparatus of claim 8, wherein the extra pressure is between 10 and 20 mm Hg extra pressure.

10. The therapeutic compression apparatus of claim 1 wherein the inflation means is selected from the group consisting of manual pumps, static pumps, intermittent pumps, electrical inflation pumps, battery inflation pumps, gas powered inflation pumps, static pneumatic compression pumps, intermittent pneumatic pressure pumps, and the combination thereof and the inflation means for the at least one bladder is selected from the group consisting of air, gas, fluid or combinations thereof.

11. The therapeutic compression apparatus of claim 1 further comprising a face connector, a check valve and a valve cap wherein the valve cap is capable of releasing a pressure created by the inflation means within the at least one bladder.

12. The therapeutic compression apparatus of claim 11 further comprising a check valve operatively connected to the primary bladder to protect from over inflation and wherein the check valve is set to open at a predetermined pressure or a user selectable pressure.

13. The therapeutic compression apparatus of claim 1 further comprising a second bladder not connected to the first bladder, wherein the second bladder has a second inflation means and each of the first and second bladders may have different predetermined compression profiles when inflated.

14. A method for applying pressure to a portion of a human body, comprising:
affixing a wrap to a thigh, wherein the thigh wrap includes (a) at least one air bladder connected to an inflation means and wherein the at least one air bladder has a plurality of welds configured to create a predetermined compression profile when inflated and (b) an inflation port having a face connector, a check valve and a valve cap wherein the valve cap is capable of releasing a pressure created by the inflation means within the at least one air bladder;
securing the thigh wrap to the thigh with a securing means attached to the thigh wrap so that the at least one air bladder is located in the medial area of the thigh;
stabilizing the thigh wrap along a waist or hip using a stabilizing means;
inflating the at least one air bladder;
closing the valve cap on the inflation port; and
walking such that the thigh wrap is secure and stabilize on the thigh.

15. The method of claim 14, wherein the securing means includes a plurality of straps or hook and loop means.

16. The method of claim 15, wherein the inflation means is selected from the group consisting of manual pumps, static pumps, intermittent pumps, electrical inflation pumps, battery inflation pumps, gas powered inflation pumps, static pneumatic compression pumps, intermittent pneumatic pressure pumps, and the combination thereof.

17. The method of claim 15 wherein the at least one air bladder is configured to have one chamber capable of sequential gradient pressure when connected to the inflation means.

18. The method of claim 15 wherein the inflation means includes a three-way switch configured to be capable of holding a pressure created by the inflation means within the at least one bladder creating an inflated state of the bladder, capable of releasing a set amount of pressure within the at least one bladder creating a partially deflated state of the bladder, and capable of releasing all the pressure within the at least one bladder so as to create a fully deflated state of the bladder.

19. The therapeutic compression apparatus of claim 1 wherein the inflation means includes a real-time pressure measurement mechanism.

20. A thigh therapeutic compression apparatus comprising:
a primary wrap having a proximal end configured to be located along a hip or groin area of a user and a distal end of the primary wrap configured to be located at a knee of a user, the primary wrap including at least one bladder;
a secondary wrap having a proximal end and a distal end wherein the proximal end of the secondary wrap is connected to the distal end of the primary wrap;
an inflation means connected to the bladder via an inflation port on the bladder wherein the inflation port includes a check valve; and
an assembly comprising: a) a pressure mechanism having a flexible member for attachment around a limb and an air chamber which assumes a first depressurized state and a second pressurized state, said air chamber having a length and a width, said width being less than half the width of the flexible member; b) a pre-filled air bladder having a length and a width smaller than the width of the air chamber; c) an absorbent foam, sponge or dressing coupled to the pre-filled air bladder; and d) a suction conduit in fluid communication with the absorbent foam, sponge or dressing and adapted for coupling to a source of negative pressure.
